(19) United States
(12) Patent Application Publication
(10) Pub. No.: US 2017/0039697 A1
(43) Pub. Date: Feb. 9, 2017

(54) IMAGE ANALYSIS METHOD, IMAGE ANALYSIS DEVICE, IMAGE ANALYSIS SYSTEM, AND PORTABLE IMAGE ANALYSIS DEVICE

(71) Applicant: Mitsubishi Electric Corporation, Tokyo (JP)

(72) Inventors: Tomohito NAKATA, Tokyo (JP); Tetsuya TAMAKI, Tokyo (JP); Tsubasa TOMODA, Tokyo (JP)

(73) Assignee: Mitsubishi Electric Corporation, Tokyo (JP)

(21) Appl. No.: 15/304,201

(22) PCT Filed: May 20, 2015
(86) PCT No.: PCT/JP2015/064452

§ 371 Date: Oct. 14, 2016

(30) Foreign Application Priority Data
Jun. 6, 2014 (JP) 2014-117196

(51) Int. Cl. G06T 7/00; G06T 7/20

(52) U.S. Cl. CPC G06T 7/0004; G06T 7/2033; G06T 2207/10024

(57) ABSTRACT

An image analysis device for analyzing image data acquired in time series, the image analysis device including: a feature quantity calculation unit for calculating feature quantity time-series data indicating time-series change in a feature quantity, from color information about each pixel of each image data, and storing the feature quantity time-series data in a feature quantity time-series DB; and a variation cycle calculation unit for extracting the feature quantity time-series data from the feature quantity time-series DB and calculating a variation cycle of the image data.

### TECHNICAL FIELD

The present invention relates to an image analysis method, an image analysis device, an image analysis system, and a portable image analysis device that enable accurate analysis of image data and reduction in analysis load on an analyst.

### BACKGROUND ART

Workers working at a factory can vary in their speeds at which work is performed, unlike production machines which always operate at a constant speed. Therefore, analyzing variations in work cycle periods among the workers is important for analyzing the productivity in the entire factory. Conventionally, an industrial engineering (IE) method is known as a method for analyzing works of the workers.

For example, as shown in Non-Patent Document 1, methods such as a stopwatch method and a film analysis method in which a series of works performed by workers are divided into constituent work units and the lengths of work periods are measured and evaluated, are disclosed. Generally, in these methods, an analyst who performs analysis visually observes workers who are observation targets, and records times at which the work states of the observation target workers are changed, i.e., a work start time and a work finish time, and thus the analyst is required to take great effort. From such circumstances, in recent years, methods in which the work states of workers are automatically recognized using various analysis devices to reduce the analysis load on the analyst have been disclosed.

For example, as shown in Patent Document 1, a specifying method using a database composed of an “operation dictionary” and a “work dictionary” which are correspondent tables indicating the relationship between the appearance patterns of a signal waveform obtained from a sensor attached to a worker, and movement of the worker, is proposed.

For example, as shown in Patent Document 2, a method in which operation of a worker performing repetitive work is captured by a video camera, a time taken to repeatedly pass through a reference point set on a reproduction display is calculated, and the work cycle is measured, is proposed.

As a technique for analyzing work using a video camera, for example, as shown in Patent Document 3, a technique of recognizing movement of a predetermined part of the body of a worker from change in color information or the like of captured image data, is proposed.

For example, as shown in Patent Document 4, a technique of discriminating a moving object and a background without limiting the recognition target to a human body, is proposed.

### CITATION LIST

### Patent Document

Patent Document 1: Japanese Patent Publication No. 5159263
Patent Document 2: Japanese Patent Publication No. 2711548
Patent Document 3: Japanese Patent Publication No. 4792824
Patent Document 4: Japanese Laid-Open Patent Publication No. 2003-6659

### Non-Patent Document

Non-Patent Document 1: FUJITA AKIHISA, “New edition the basics of IE”, KENPAKUSHA (issued in January, 2007)

### SUMMARY OF THE INVENTION

### Problems to be Solved by the Invention

For the conventional work analysis method for workers at a factory, a technique for reducing analysis load on an analyst is required. However, in the method for analyzing work using a correspondence table of a sensor signal and worker movement as shown in Patent Document 1, apart from the case of simple movements such as walking and stop, there is a problem that great labor is required for preparing a correspondence table for all the complicated works and this is not realistic.

In the conventional technique of capturing movement of a worker using a video camera as shown in Patent Document 2, it is required to recognize the movement on the basis of whether or not a part of the body of the worker passes through a reference space defined in advance on an image. Therefore, there is a problem that it takes effort to perform setting of the reference space on the image and perform recognition of a part of the body.

As shown in Patent Document 3, color information of image data is used for recognition of a part of the body. However, generally, workers at a factory often wear various protectors such as helmets and gloves, and therefore there is a problem that it is often difficult to determine a part of the body of a worker from the color information.

As shown in Patent Document 4, in the technique of discriminating a moving object and background information, discrimination between a moving object and a background is performed by comparing the feature quantity of the same pixel between the previous and next frames of moving image data. However, in the case where some objects are constantly moving as in a factory, e.g., in the case where a conveyor belt is moving or a ventilation fan is rotating, there is a problem that irrelevant objects are also recognized and thus it becomes difficult to perform analysis.

That is, in any of the conventional cases, there is a problem of taking great effort for analysis or deteriorating the analysis accuracy in a factory.

The present invention has been made to solve the above problems, and an object of the present invention is to provide an image analysis method, an image analysis device, an image analysis system, and a portable image analysis device that enable accurate analysis of image data and reduction in analysis load on an analyst.

### Solution to the Problems

The image analysis method according to the present invention is an image analysis method for analyzing image data acquired in time series, the image analysis method including: a step of acquiring color information about each pixel of each image data; a step of calculating feature quantity time-series data indicating time-series change in a feature quantity of each pixel, from the color information; and a step of calculating a variation cycle of the image data from the feature quantity time-series data.

An image analysis device according to the present invention is an image analysis device for analyzing image data acquired in time series, the image analysis device including: a feature quantity calculation unit for calculating feature quantity time-series data indicating time-series change in a feature quantity, from color information about each pixel of each image data; and a variation cycle calculation unit for calculating a variation cycle of the image data from the feature quantity time-series data.

An image analysis system according to the present invention includes: the image analysis device; an imaging device for acquiring the image data; a display device for displaying a result of analysis by the image analysis device; an image database in which the image data are stored; a feature quantity time-series database in which the feature quantity time-series data are stored; and an image analysis database in which the result of analysis is stored.

A portable image analysis device according to the present invention includes the image analysis system, wherein the image analysis device, the imaging device, the display device, the image database, the feature quantity time-series database, and the image analysis database are configured so as to be integrated and portable.

### Effect of the Invention

The image analysis method, the image analysis device, the image analysis system, and the portable image analysis device according to the present invention enable accurate analysis of image data and reduction in analysis load on an analyst.

### BRIEF DESCRIPTION OF THE DRAWINGS

FIG. 1 is a diagram showing the configuration of an image analysis system having an image analysis device according to embodiment 1 of the present invention.

FIG. 2 is a diagram for explaining operation of a feature quantity calculation unit of the image analysis device shown in FIG. 1.

FIG. 3 is a diagram showing the configuration of pixels of image data used in the image analysis device shown in FIG. 1.

FIG. 4 is a diagram showing color information used for processing of image data in the image analysis device shown in FIG. 1.

FIG. 5 is a diagram showing the order of acquisition of color information about image data in the feature quantity calculation unit shown in FIG. 2.

FIG. 6 is a diagram showing color information acquired as shown in FIG. 5, about each pixel of the image data acquired in FIG. 2.

FIG. 7 is a diagram showing color pallet data set in the feature quantity calculation unit shown in FIG. 2.

FIG. 8 is a diagram showing color pallet numbers of pixels in the color information acquired in FIG. 6.

FIG. 9 is a diagram showing a neighborhood image region for acquiring color information entropy of each pixel in the feature quantity calculation unit shown in FIG. 2.

FIG. 10 is a diagram showing another neighborhood image region for acquiring color information entropy of each pixel in the feature quantity calculation unit shown in FIG. 2.

FIG. 11 is a diagram showing an acquisition example of color information entropy of a given pixel acquired in the feature quantity calculation unit shown in FIG. 2.

FIG. 12 is a diagram for explaining change in color information entropy of a given pixel acquired in the feature quantity calculation unit shown in FIG. 2.

FIG. 13 is a diagram showing the change states in time series, of color information entropy of a given pixel acquired in the feature quantity calculation unit shown in FIG. 2.

FIG. 14 is a diagram showing time-series data of color information entropy of each image acquired in the feature quantity calculation unit shown in FIG. 2.

FIG. 15 is a diagram showing, in grayscale, information at a given point of time about color information entropy of image data acquired in the feature quantity calculation unit shown in FIG. 2.

FIG. 16 is a diagram for explaining operation of a variation cycle calculation unit of the image analysis device shown in FIG. 1.

FIG. 17 is a graph showing the time-series data of color information entropies acquired in FIG. 14.

FIG. 18 is a graph obtained by extracting a part of the time-series data of color information entropies shown in FIG. 17.

FIG. 19 is a graph obtained by extracting a part of the time-series data of color information entropies shown in FIG. 17.

FIG. 20 is a diagram showing the relationship between a pixel position and a moving object on image data.

FIG. 21 is a diagram for explaining time shift for the time-series data shown in FIG. 17.

FIG. 22 is a diagram showing an autocorrelation coefficient per time shift for the color information entropy of each pixel shown in FIG. 17.

FIG. 23 is a graph showing the autocorrelation coefficient per time shift for each pixel shown in FIG. 22.

FIG. 24 is a diagram showing the average value of the autocorrelation coefficients for the pixels per time shift shown in FIG. 23.

FIG. 25 is a graph showing the average value of the autocorrelation coefficients for the pixels per time shift shown in FIG. 24.

FIG. 26 is a graph obtained by performing Fourier transform for the average value of the autocorrelation coefficients for the pixels per time shift shown in FIG. 25.

FIG. 27 is a diagram obtained by extracting time shift, an autocorrelation coefficient, and an initial time for the local maximum of the autocorrelation coefficient for each pixel, from the color information entropies shown in FIG. 17 and the autocorrelation coefficients shown in FIG. 23.

FIG. 28 is a diagram obtained by extracting data having a variation cycle from FIG. 27.

FIG. 29 is a diagram for explaining the situation in which there are different initial times in FIG. 28.

FIG. 30 is a diagram obtained by extracting work points from FIG. 29.

FIG. 31 is a diagram obtained by extracting times for the local maximums of autocorrelation coefficients for the work points extracted in FIG. 30.

FIG. 32 is a diagram showing work periods calculated from the times shown in FIG. 30.

FIG. 33 is a diagram showing a probability density with respect to the work period in FIG. 32.

FIG. 34 is a graph showing the time-series data of color information entropy of a given pixel of the image data acquired in FIG. 14.

FIG. 35 is a graph showing the autocorrelation coefficient per time shift for the pixel shown in FIG. 34.

FIG. 36 is a graph obtained by performing Fourier transform for the autocorrelation coefficient for the pixel per time shift shown in FIG. 35.

FIG. 37 is a graph showing time-series data of color information entropy of a given pixel of image data including work interruption, acquired in FIG. 14.

FIG. 38 is a graph showing the autocorrelation coefficient per time shift for the pixel shown in FIG. 37.

FIG. 39 is a graph obtained by performing Fourier transform for the autocorrelation coefficient for the pixel per time shift shown in FIG. 38.

FIG. 40 is a graph obtained by performing Fourier transform for the color information entropy of the pixel shown in FIG. 37.

FIG. 41 is a diagram for explaining operation of a feature quantity calculation unit of an image analysis device according to embodiment 2 of the present invention.

FIG. 42 is a diagram showing the appearance frequency for each hue in image data acquired by the feature quantity calculation unit shown in FIG. 41.

FIG. 43 is a diagram showing the appearance frequency for each hue shown in FIG. 41, in an equally divided manner in terms of hue.

FIG. 44 is a diagram showing, in descending order, the appearance frequency for each hue in the image data shown in FIG. 41, and showing mountain hues extracted therefrom.

FIG. 45 is a diagram obtained by rearranging, in hue order, the appearance frequencies arranged in descending order shown in FIG. 44, and extracting valley hues.

FIG. 46 is a diagram showing the state of color pallet numbers set from the valley hues shown in FIG. 45.

FIG. 47 is a graph showing the appearance frequency for each hue shown in FIG. 41, with the hue divided into the color pallet numbers shown in FIG. 46.

FIG. 48 is a diagram showing the configuration of a portable image analysis device according to embodiment 3 of the present invention.

FIG. 49 is a diagram showing the configuration of an image analysis system having an image analysis device, according to embodiment 4 of the present invention.

### DESCRIPTION OF EMBODIMENTS

### Embodiment 1

Hereinafter, embodiments of the present invention will be described. In image analysis described in the following embodiments, the case where, in a facility such as a factory, a worker as a moving object performs a work as a cyclic operation (repetitive operation) and a work cycle period as a repetition period of the work is analyzed will be described as an example. It is noted that, even for work performed by a moving object other than a worker, e.g., a machine, image analysis can be performed in the same manner. In addition, even in the case other than work, the same effect can be provided in analysis of image data that varies repeatedly.

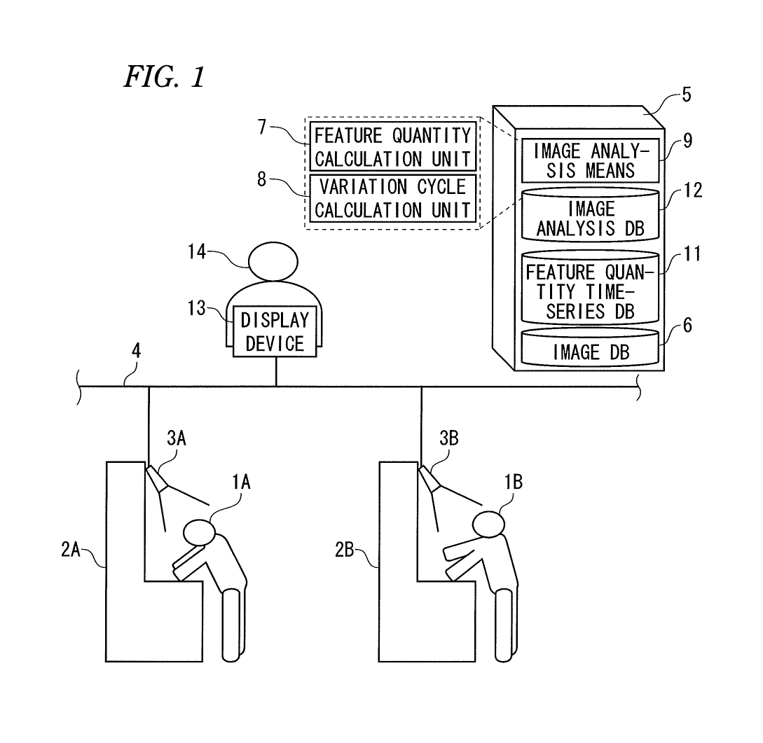

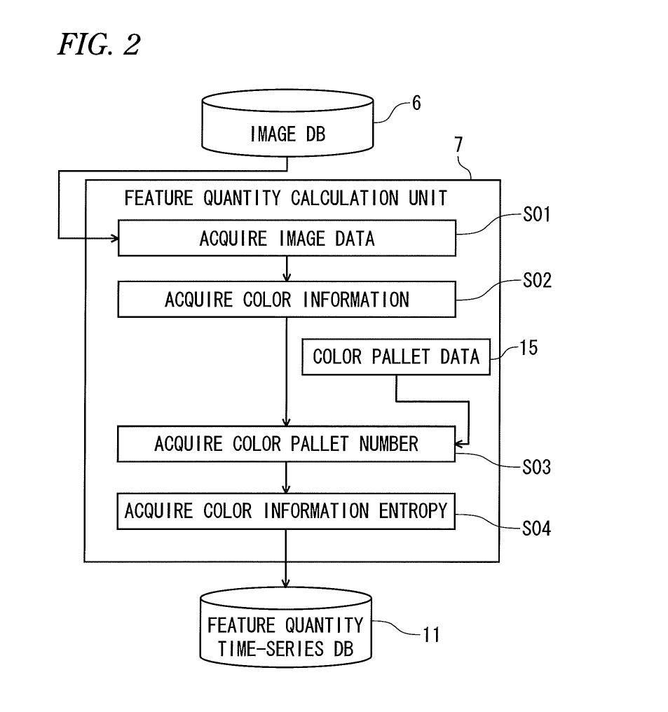

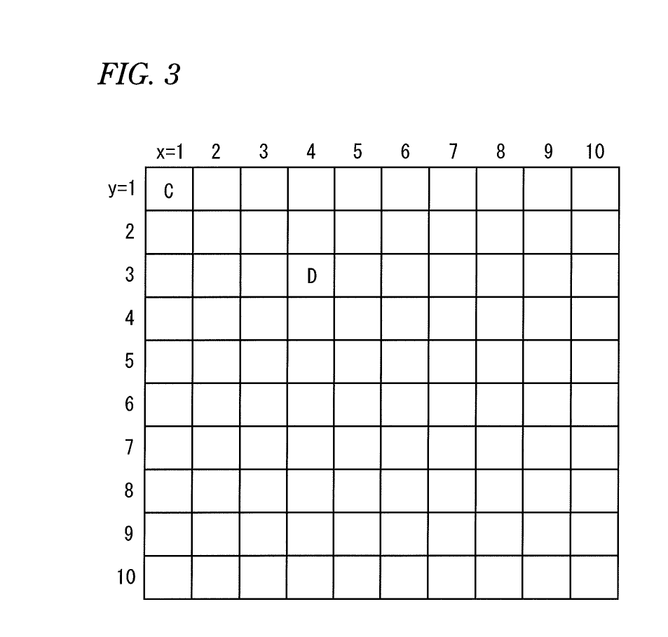

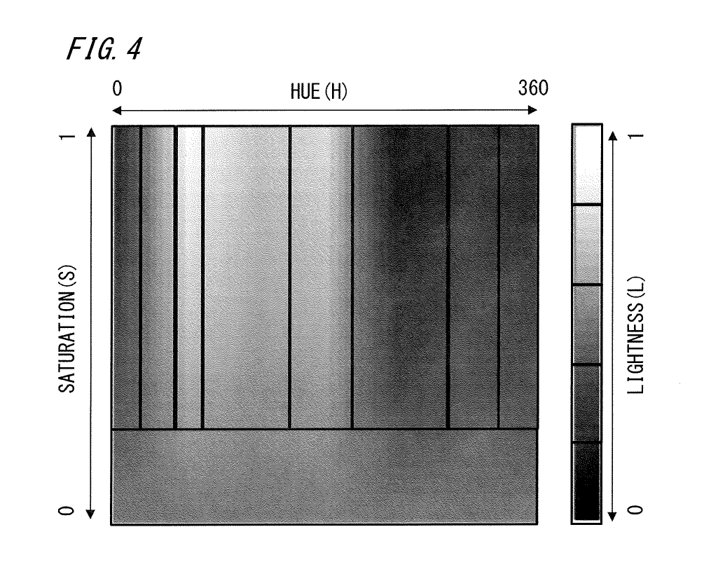

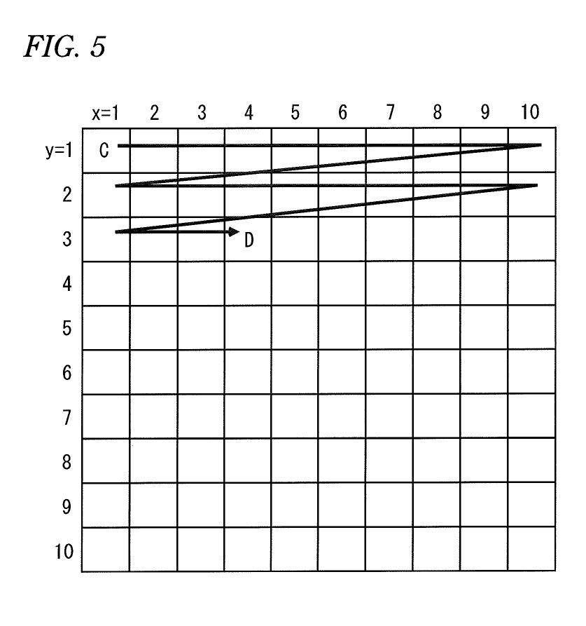

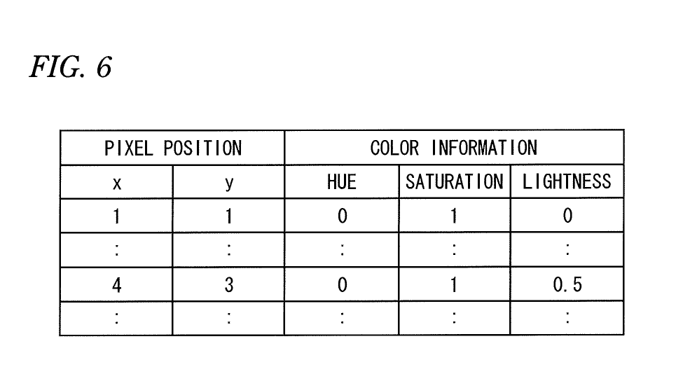

FIG. 1 is a diagram showing the configuration of an image analysis system having an image analysis device according to embodiment 1 of the present invention. FIG. 2 is a diagram for explaining operation of a feature quantity calculation unit of the image analysis device shown in FIG. 1. FIG. 3 is a diagram showing the configuration of pixels of image data used in the image analysis device shown in FIG. 1. FIG. 4 is a diagram showing color information used for processing of image data in the image analysis device shown in FIG. 1. FIG. 5 is a diagram showing the order of acquisition of color information about image data in the feature quantity calculation unit shown in FIG. 2. FIG. 6 is a diagram showing color information acquired as shown in FIG. 5, about each pixel of the image data acquired in FIG. 2.

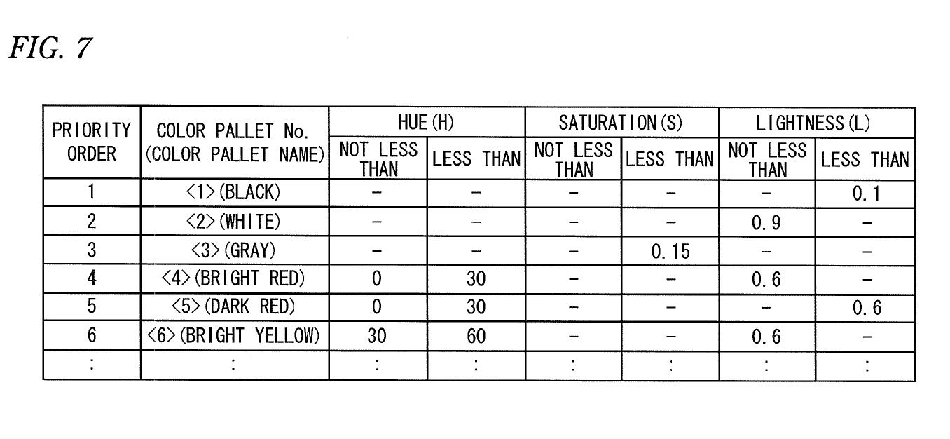

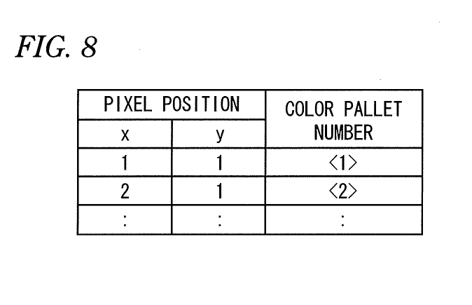

FIG. 7 is a diagram showing color pallet data set in the feature quantity calculation unit shown in FIG. 2. FIG. 8 is a diagram showing color pallet numbers of pixels in the color information acquired in FIG. 6.

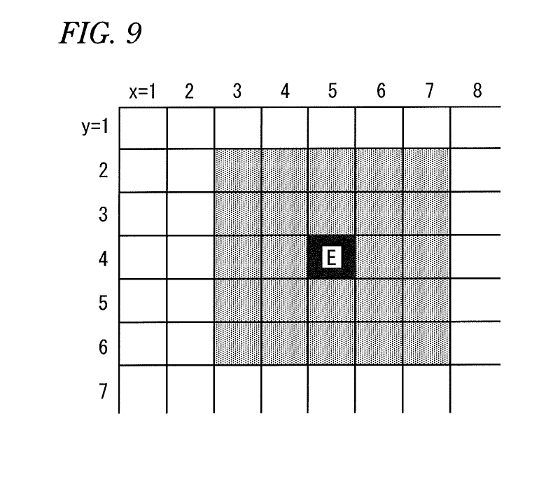

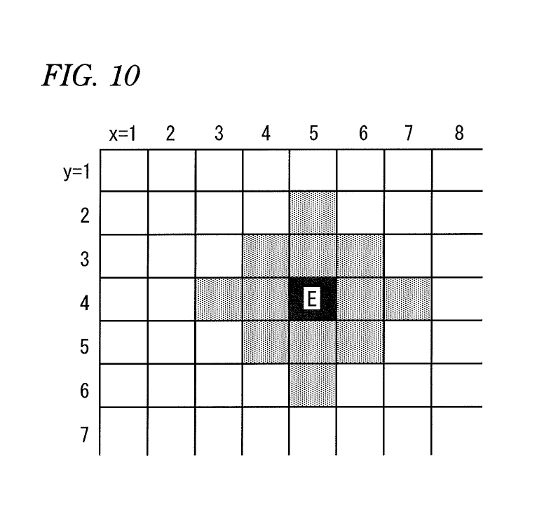

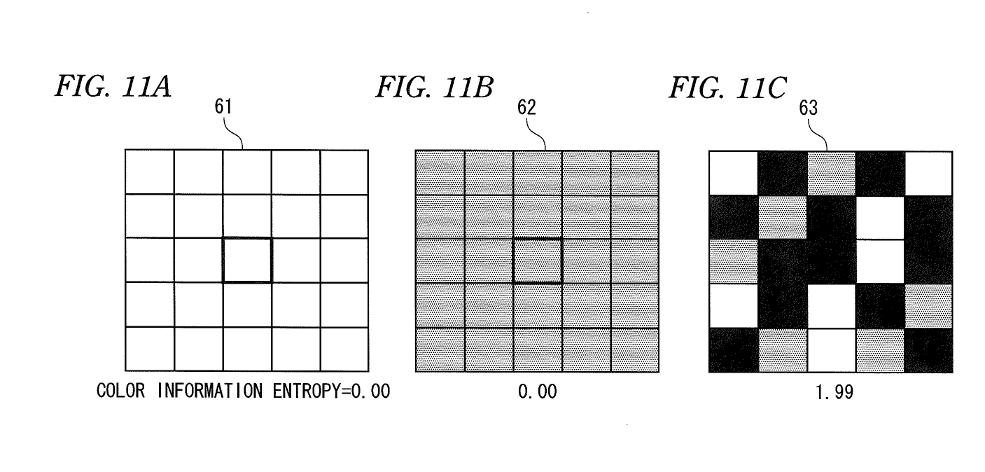

FIG. 9 is a diagram showing a neighborhood image region for acquiring information entropy (hereinafter, referred to as “color information entropy”) of each pixel in the feature quantity calculation unit shown in FIG. 2. FIG. 10 is a diagram showing another neighborhood image region for acquiring color information entropy of each pixel in the feature quantity calculation unit shown in FIG. 2. FIG. 11 is a diagram showing an acquisition example of color information entropy of a given pixel acquired in the feature quantity calculation unit shown in FIG. 2.

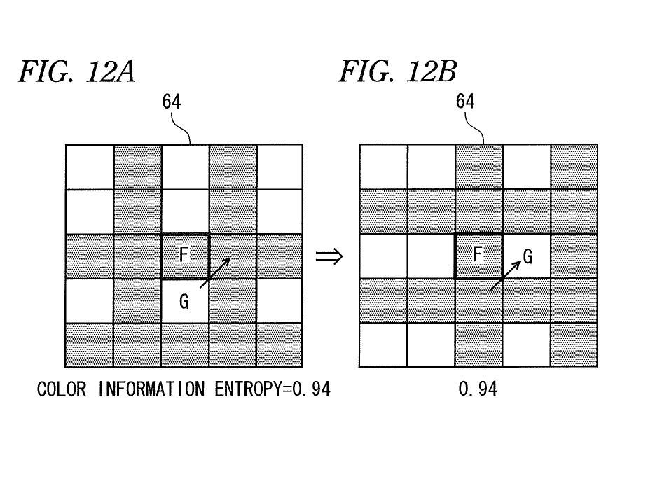

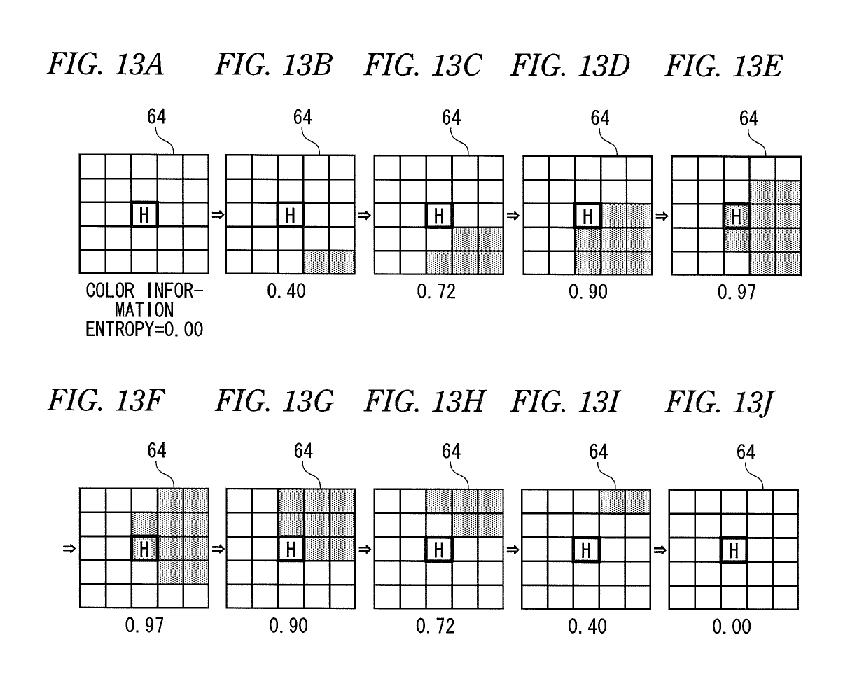

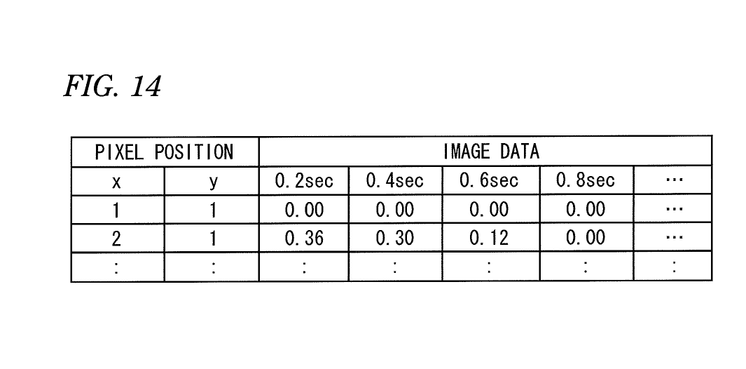

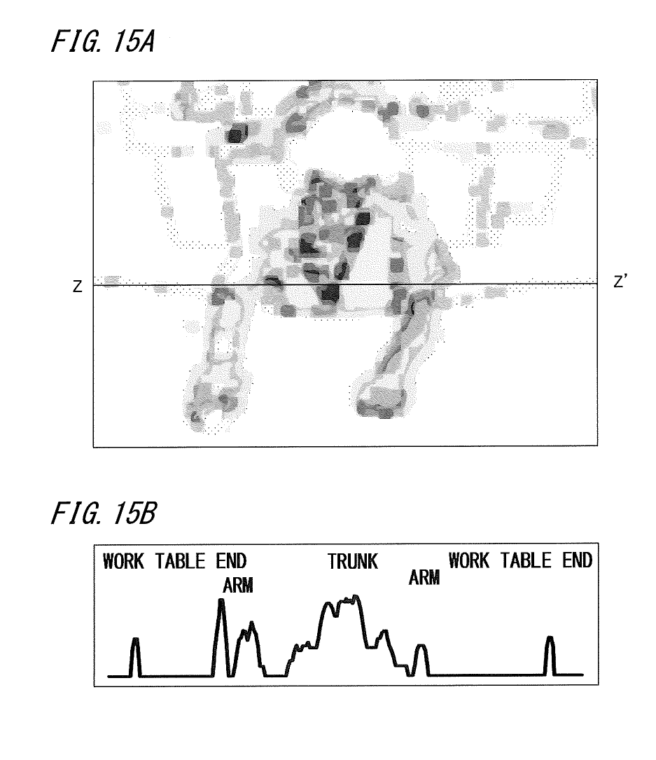

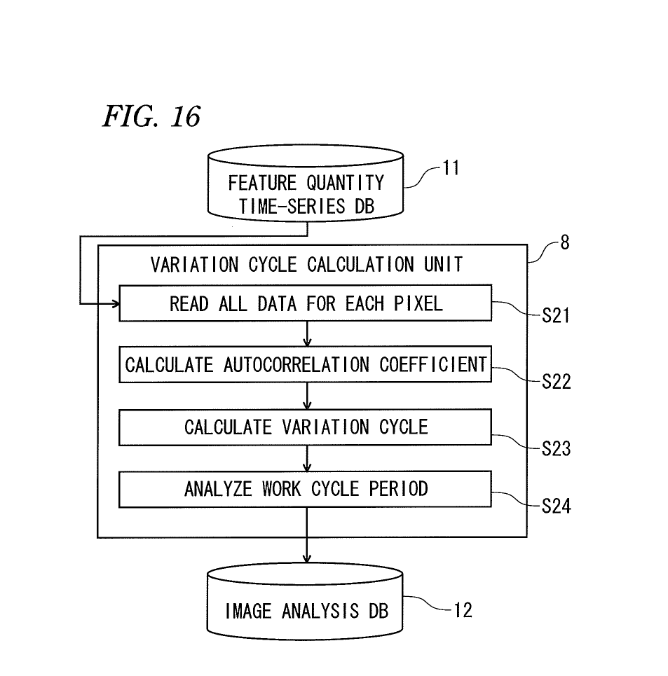

FIG. 12 is a diagram for explaining change in color information entropy of a given pixel acquired in the feature quantity calculation unit shown in FIG. 2. FIG. 13 is a diagram showing the change states in time series, of color information entropy of a given pixel acquired in the feature quantity calculation unit shown in FIG. 2. FIG. 14 is a diagram showing time-series data of color information entropy of each image acquired in the feature quantity calculation unit shown in FIG. 2. FIG. 15 is a diagram showing, in grayscale, information at a given point of time about color information entropy of image data acquired in the feature quantity calculation unit shown in FIG. 2. FIG. 16 is a diagram for explaining operation of a variation cycle calculation unit of the image analysis device shown in FIG. 1.

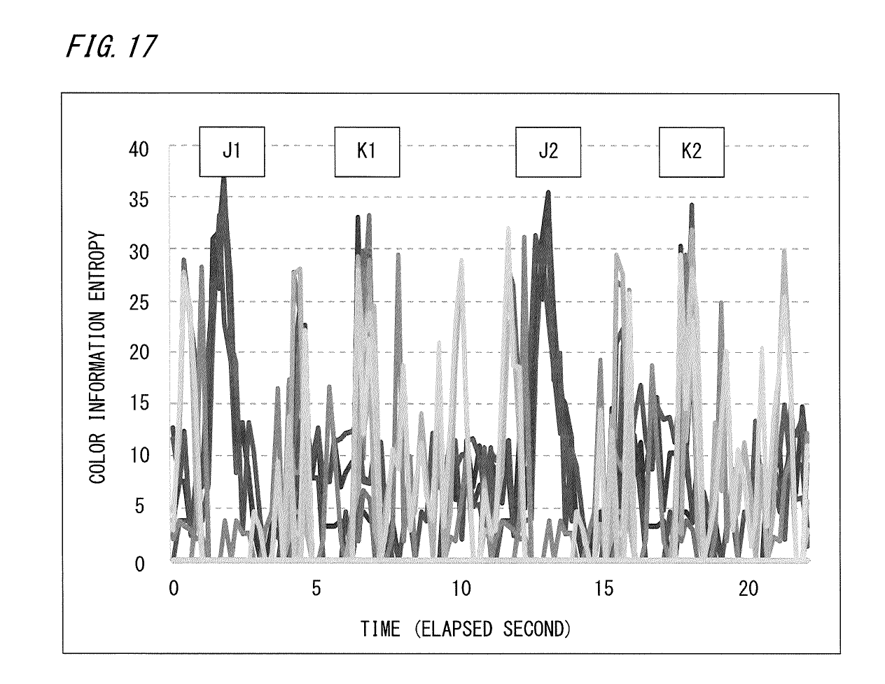

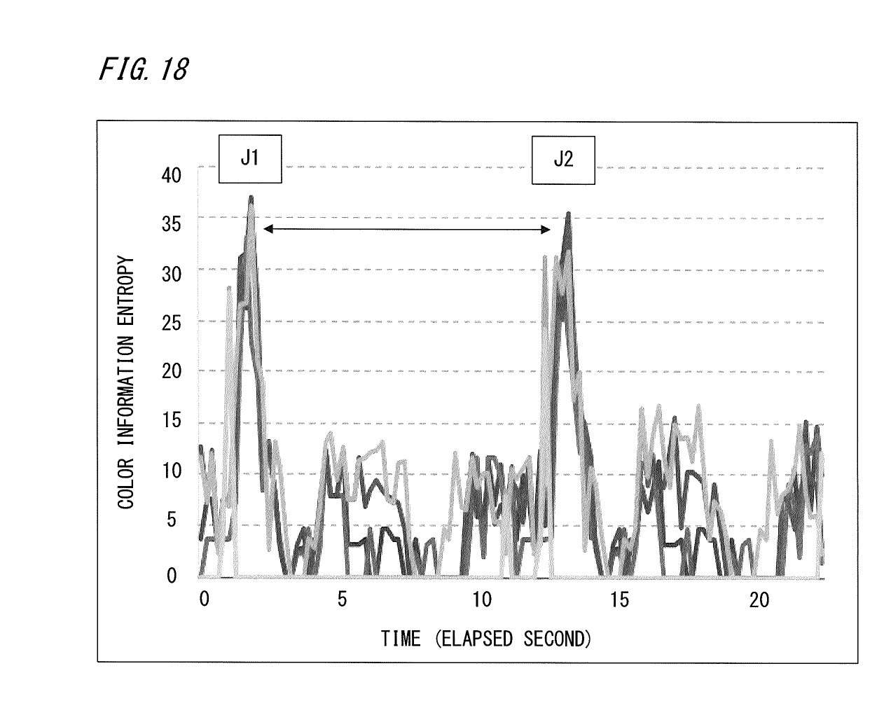

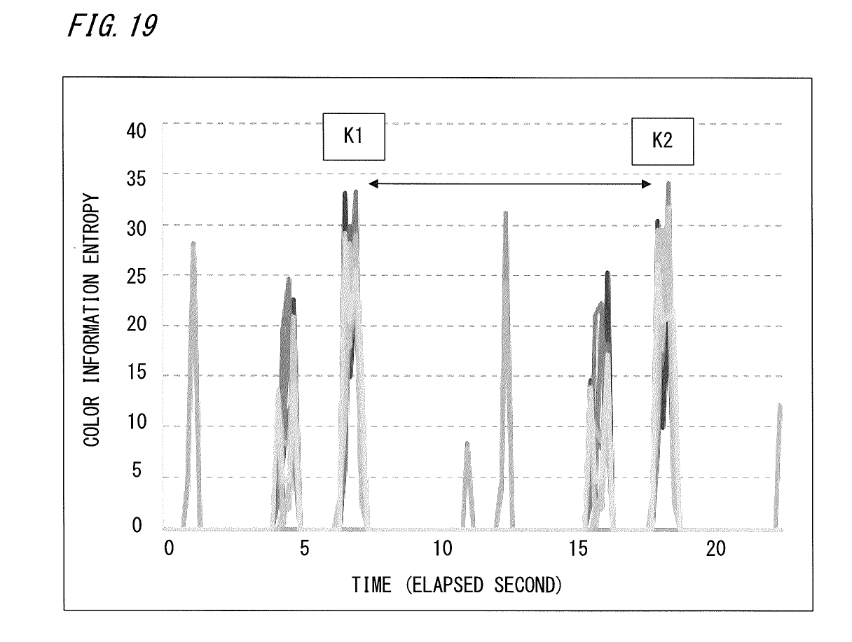

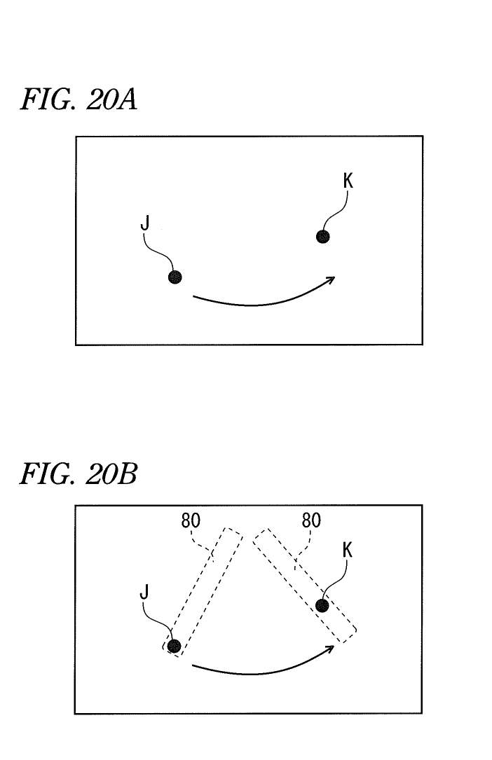

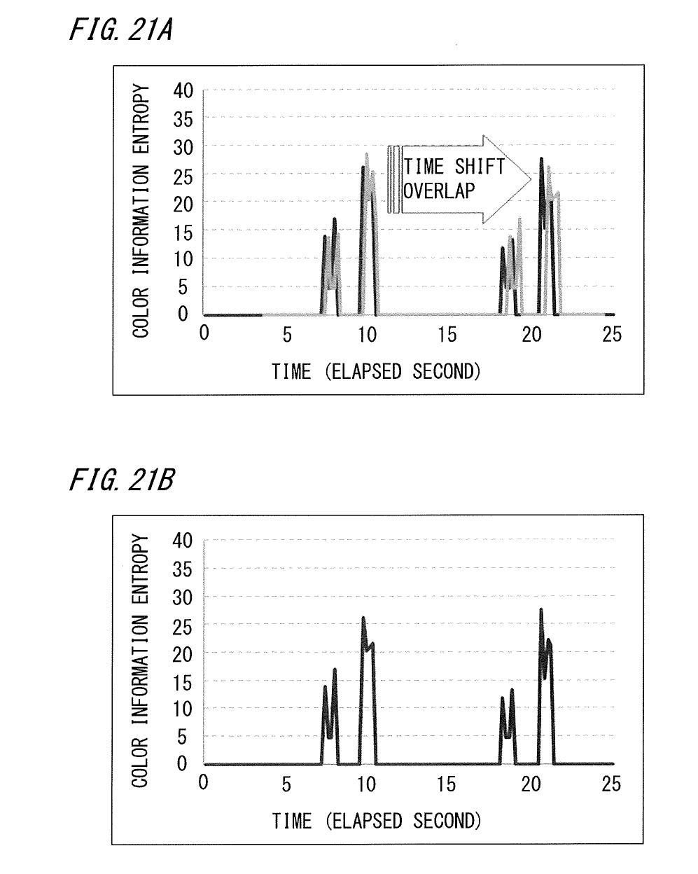

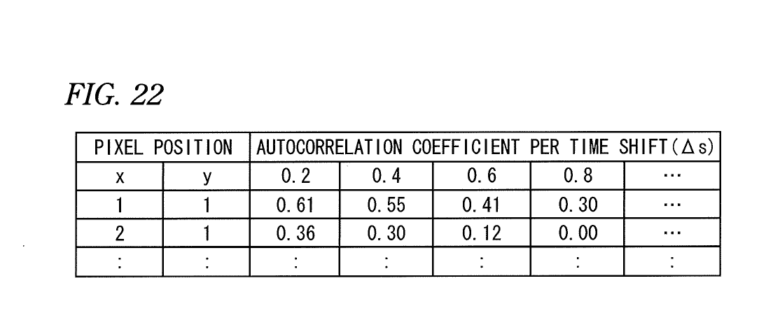

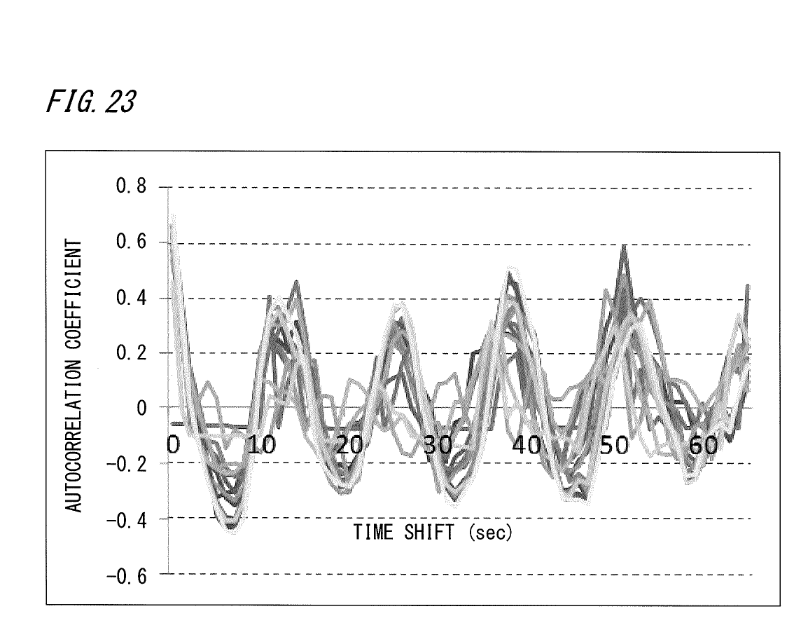

FIG. 17 is a graph showing the time-series data of color information entropies acquired in FIG. 14. FIG. 18 and FIG. 19 are graphs each obtained by extracting a part of the time-series data of color information entropies shown in FIG. 17. FIG. 20 is a diagram showing the relationship between a pixel position and a moving object on image data. FIG. 21 is a diagram for explaining time shift for the time-series data shown in FIG. 17. FIG. 22 is a diagram showing an autocorrelation coefficient per time shift for the color information entropy of each pixel shown in FIG. 17. FIG. 23 is a graph showing the autocorrelation coefficient per time shift for each pixel shown in FIG. 22.

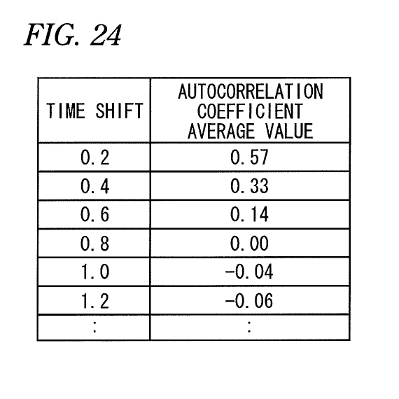

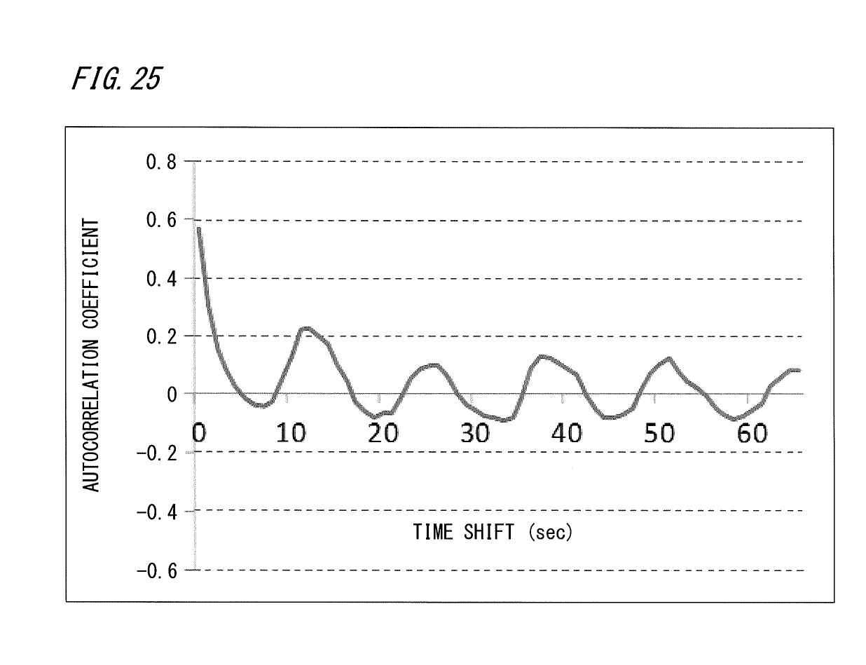

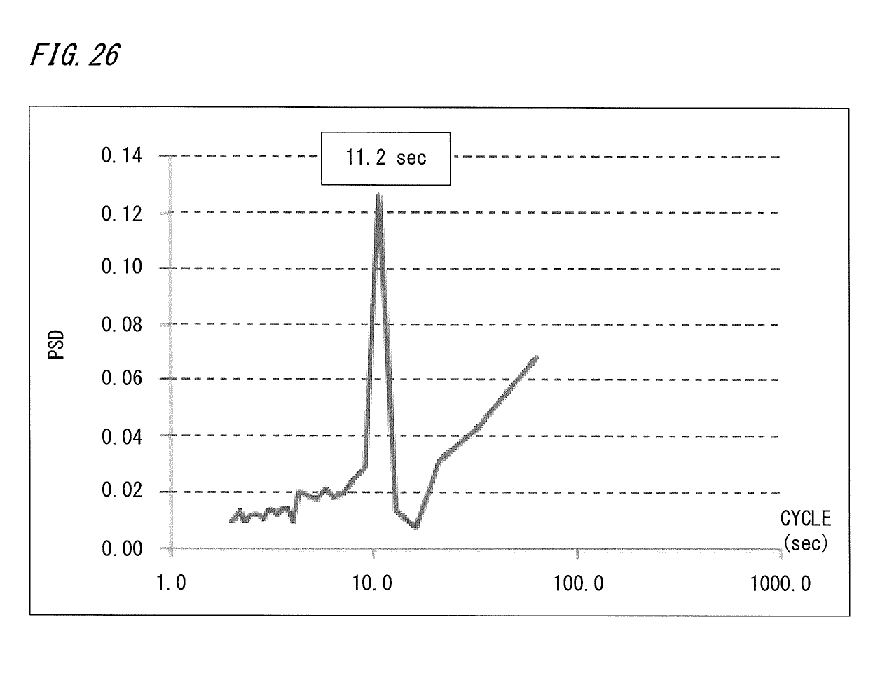

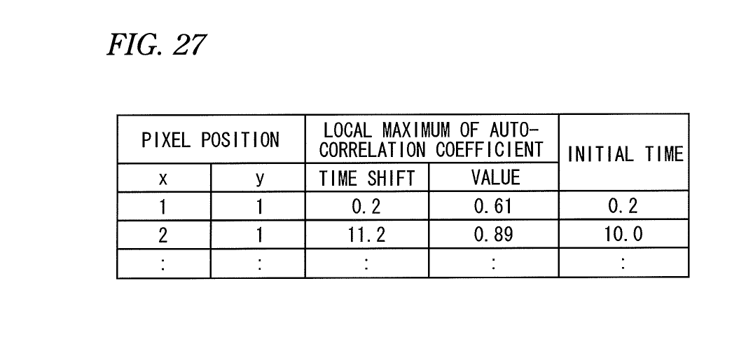

FIG. 24 is a diagram showing the average value of the autocorrelation coefficients for the pixels per time shift shown in FIG. 23. FIG. 25 is a graph showing the average value of the autocorrelation coefficients for the pixels per time shift shown in FIG. 24. FIG. 26 is a graph obtained by performing Fourier transform for the average value of the autocorrelation coefficients for the pixels per time shift shown in FIG. 25. FIG. 27 is a diagram obtained by extracting time shift, an autocorrelation coefficient, and an initial time for the local maximum of the autocorrelation coefficient for each pixel.

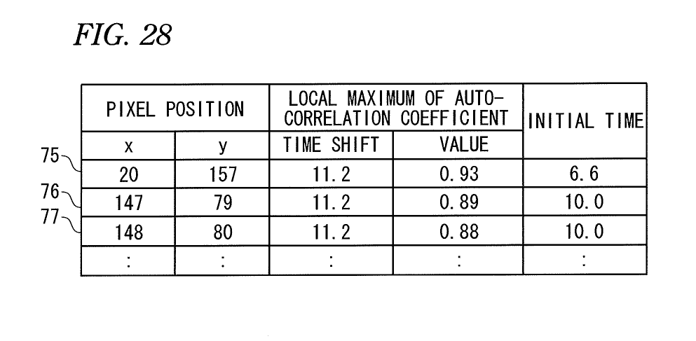

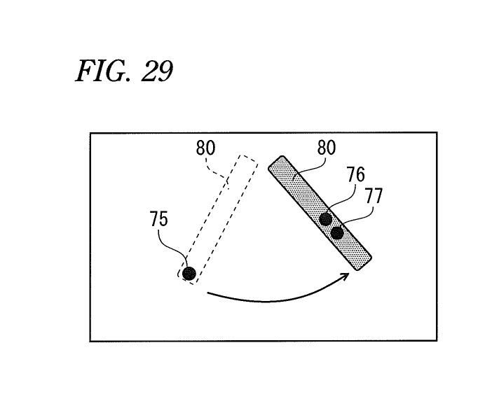

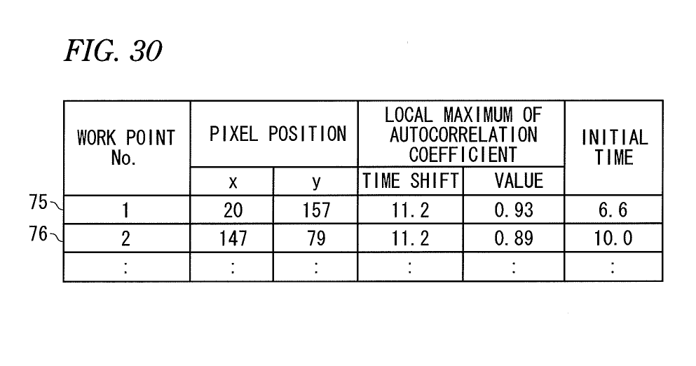

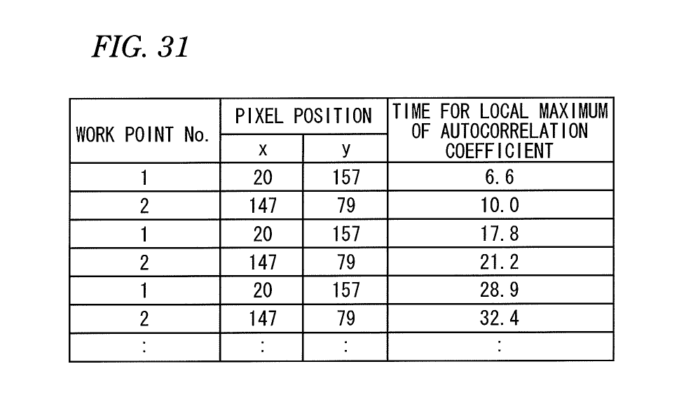

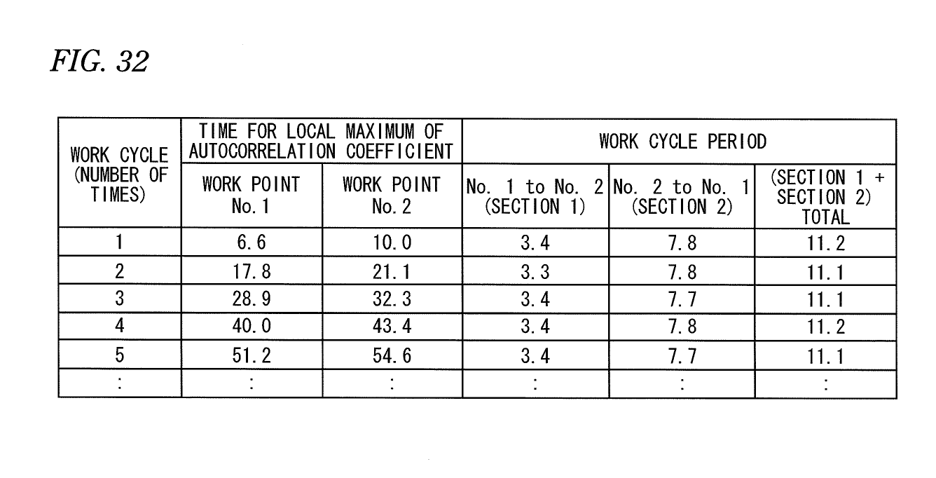

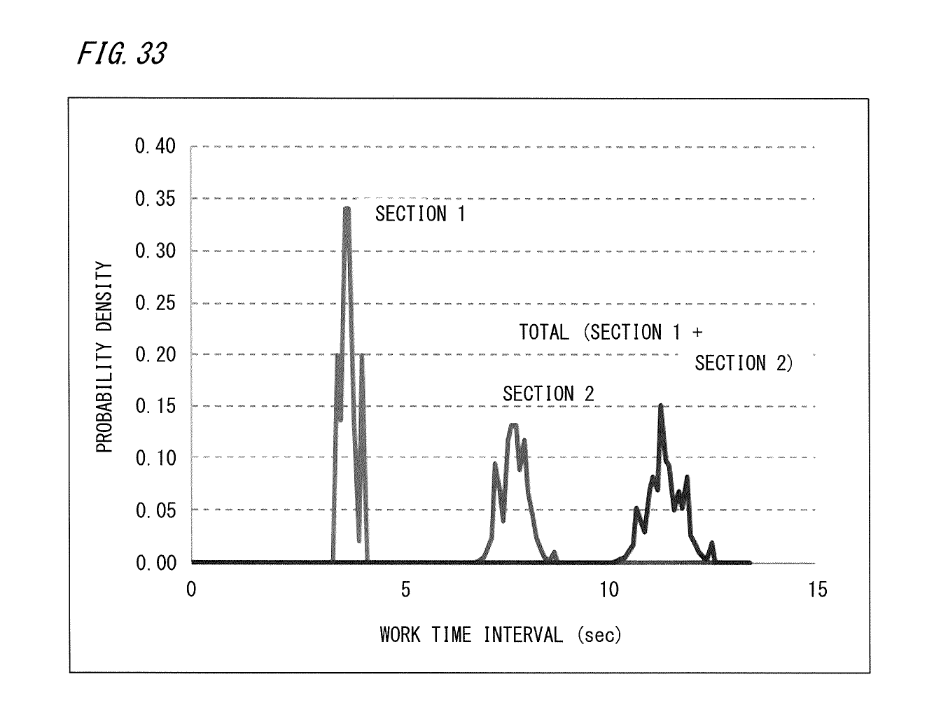

FIG. 28 is a diagram obtained by extracting data having a variation cycle from FIG. 27. FIG. 29 is a diagram for explaining the situation in which there are different initial times in FIG. 28. FIG. 30 is a diagram obtained by extracting work points from FIG. 29. FIG. 31 is a diagram obtained by extracting times for the local maximums of autocorrelation coefficients for the work points extracted in FIG. 30. FIG. 32 is a diagram showing work periods calculated from the times shown in FIG. 30. FIG. 33 is a diagram showing a probability density with respect to the work period in FIG. 32.

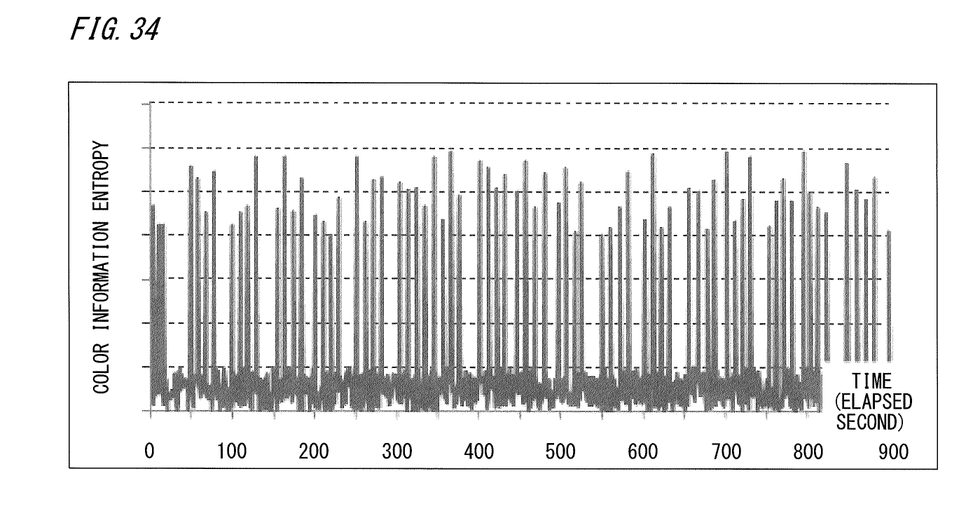

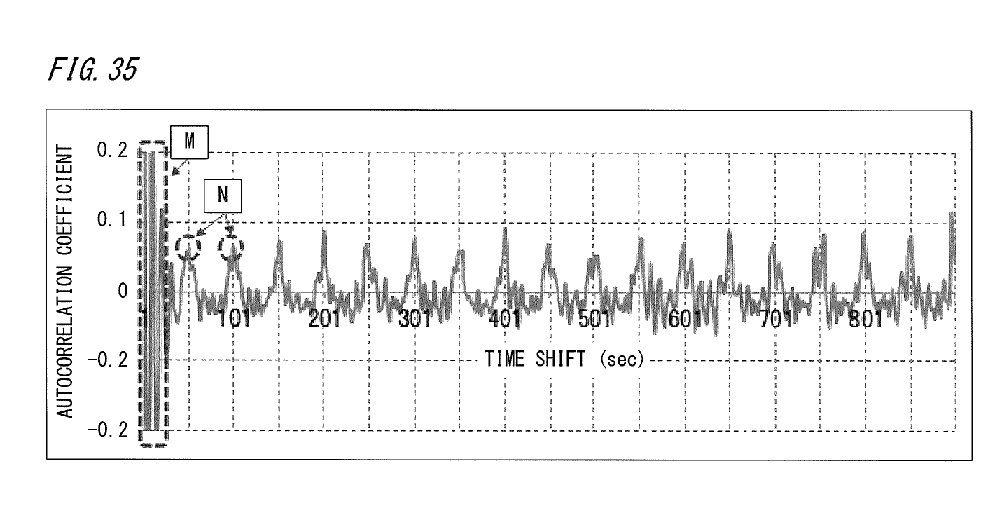

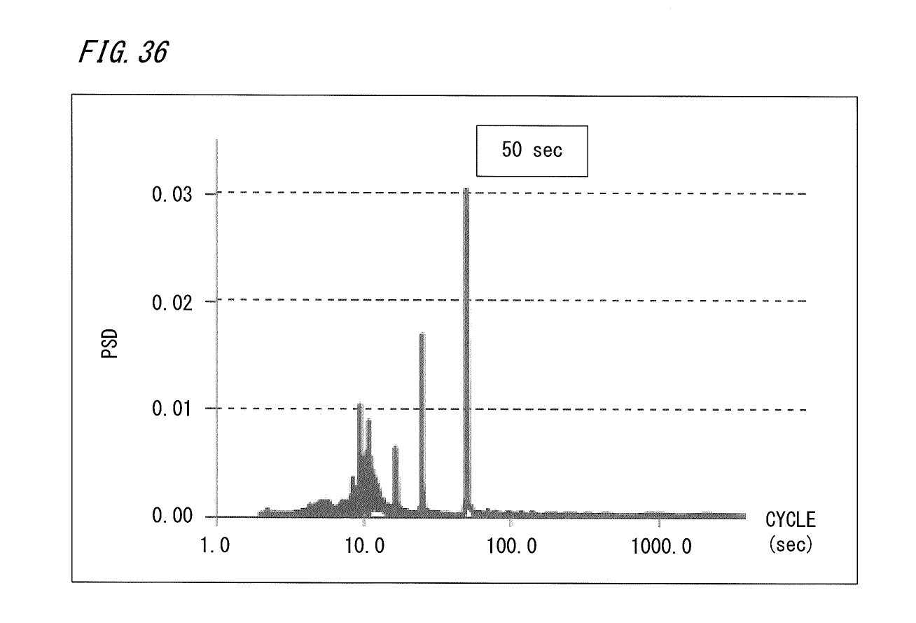

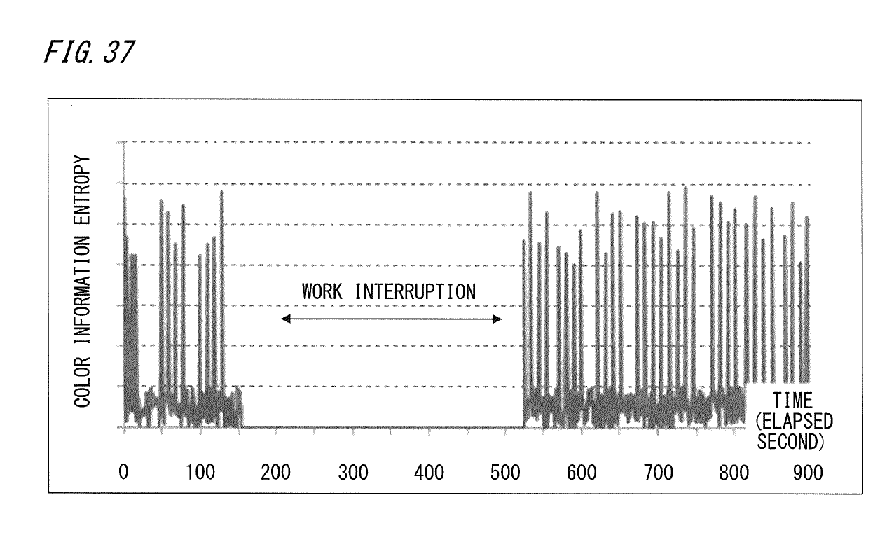

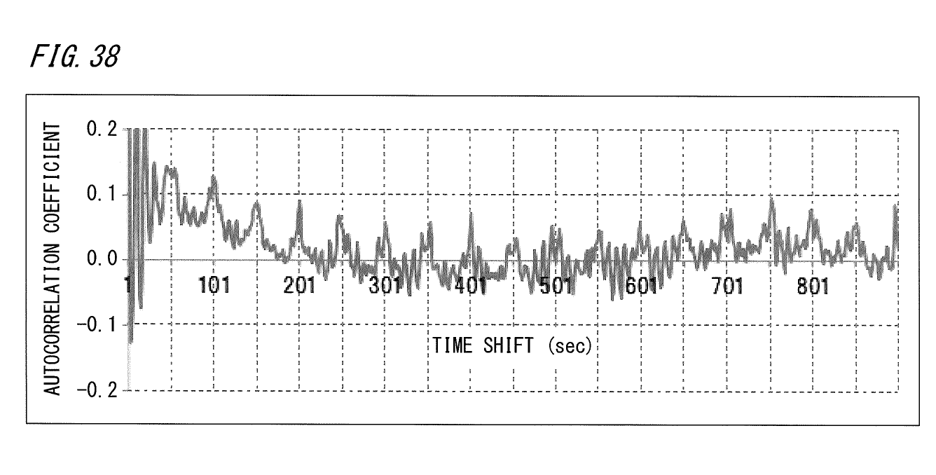

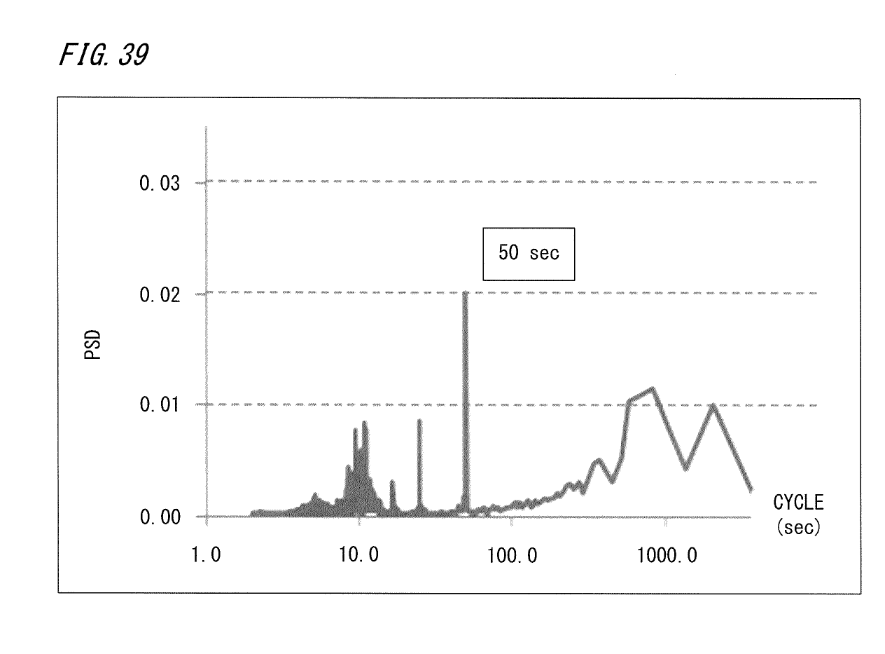

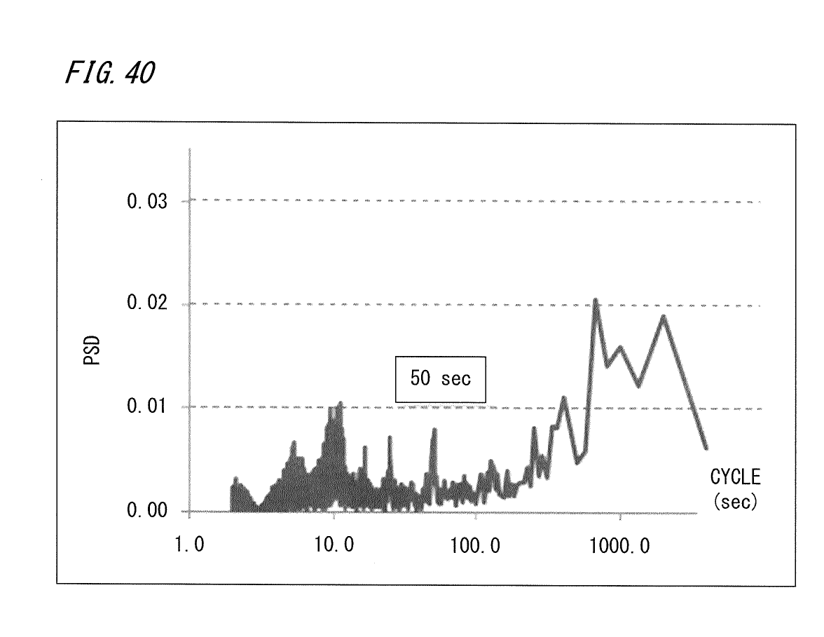

FIG. 34 is a graph showing the time-series data of color information entropy of a given pixel of the image data acquired in FIG. 14. FIG. 35 is a graph showing the autocorrelation coefficient per time shift for the pixel shown in FIG. 34. FIG. 36 is a graph obtained by performing Fourier transform for the autocorrelation coefficient for the pixel per time shift shown in FIG. 35. FIG. 37 is a graph showing time-series data of color information entropy of a given pixel of image data including work interruption, acquired in FIG. 14. FIG. 38 is a graph showing the autocorrelation coefficient per time shift for the pixel shown in FIG. 37. FIG. 39 is a graph obtained by performing Fourier transform for the autocorrelation coefficient for the pixel per time shift shown in FIG. 38. FIG. 40 is a graph obtained by performing Fourier transform for the color information entropy of the pixel shown in FIG. 37.

In FIG. 1, an image analysis device 5 includes: an image database (hereinafter, database is abbreviated as DB) 6 in which image data acquired in time series are stored; a feature quantity time-series DB 11 in which feature quantity time-series data of image data are stored; an image analysis DB 12 in which image analysis data from the image data are stored; and image analysis means 9 for analyzing the image analysis data from the image data. The image analysis means 9 includes: a feature quantity calculation unit 7 for detecting a feature quantity from the image data; and a variation cycle calculation unit 8 for detecting a variation cycle of the feature quantity of the image data.

The image analysis device 5 is connected to a wired or wireless communication network 4. A worker 1A and a worker 1B are working on a worktable 2A and a worktable 2B which are stationary. Their working states are captured by an imaging device 3A and an imaging device 3B, and are outputted as image data. The image data from the imaging devices 3A and 3B are stored in the image DB 6 via the communication network 4. The image analysis data analyzed by the image analysis device 5 are displayed on a display device 13 for an analyst 14 via the communication network 4.

The operation of the image analysis device of embodiment 1 configured as described above will be described. First, the worker 1A and the worker 1B are working on the worktable 2A and the worktable 2B. Then, their working states are captured by the imaging device 3A and the imaging device 3B, and outputted as a plurality of image data in time series to the communication network 4. Then, the image data are stored in the image DB 6 via the communication network 4. Next, the feature quantity calculation unit 7 acquires the image data from the image DB 6 (step S01 in FIG. 2).

Next, color information at each pixel of each image data is acquired (step S02 in FIG. 2). Specifically, each image data is composed of, for example, as shown in FIG. 3, one hundred pixels of ten pixels in the x-axis (horizontal) direction×ten pixels in the y-axis (vertical) direction. The pixels of image data are grid sections composing the image data in FIG. 3. For example, as shown in FIG. 3, a pixel C is positioned at “x=1, y=1”, and a pixel D is positioned at “x=4, y=3”. For the color information acquired here, for example, as shown in FIG. 4, HLS color space is used which expresses the color information with three components: “hue” which indicates a color tone by an angle of 0 to 360° (deg), “saturation” which indicates colorfulness of color by 0 to 1 (=100%), and “lightness” which indicates brightness of color by 0 to 1 (=100%) (in FIG. 4, the actual colors are simply shown in monochrome).

Although an example in which HLS color space is used is described in the present embodiment, without limitation thereto, any means that allows color information of each pixel to be expressed numerically may be used. For example, another color space such as RGB color space or HSV color space may be used. Then, as indicated by an arrow in FIG. 5, for all pixels in one image data (also referred to as one image frame), color information is sequentially acquired along the x axis and the y axis. The acquired color information of each pixel is 3-dimensional color information composed of hue, saturation, and lightness such as, for example, as shown in FIG. 6, color information “hue=0°, saturation=1, lightness=0” of the pixel C at the pixel position “x=1, y=1”, or color information “hue=0°, saturation=1, lightness=0.5” of the pixel D at the pixel position “x=4, y=3”.

Next, for the color information of each pixel of each image data, a color pallet number is acquired on the basis of color pallet data 15 (step S03 in FIG. 2). Specifically, in the color pallet data 15, similar types of colors are classified into the same color group and different types of colors are classified into different color groups, using color pallet numbers. For the color pallet numbers, priority orders for detection are set respectively.

The color pallet numbers and the priority orders are set in advance as appropriate on the basis of image data to be analyzed. The number of the color pallet data 15 is set as appropriate in accordance with the importance of color information that appears in image data to be analyzed. Specifically, the number of colors (the number of color pallet numbers) to be classified and discriminated by the color pallet to be generated is desired to be about the number of pixels in a “neighborhood pixel region” used for color information entropy described later. The same also applies to the other embodiments below, and such description is omitted as appropriate.

For example, as shown in FIG. 7, the priority orders are determined in advance such that the first priority order is a color pallet number <1> (black) for which the lightness is less than 0.1, the second priority order is a color pallet number <2> (white) for which the lightness is not less than 0.9, and the third priority order is a color pallet number <3> (gray) for which the saturation is less than 0.15. The color information of each pixel as shown in FIG. 6 is read one by one from the highest one of the priority orders in the color pallet data 15 as shown in FIG. 7, and a color pallet number that matches the condition is allocated.

That is, for example, as shown in FIG. 6, the color information at the pixel position “x=1, y=1” is “hue=0°, saturation=1, lightness=0”, and thus matches the condition “lightness is less than 0.1” which corresponds to the first priority order in the color pallet data 15 shown in FIG. 7, and the color pallet number therefor is “<1>” as shown in FIG. 8. Thus, the matching color pallet numbers are acquired for all the pixels of all image data.

Next, on the basis of data of the color pallet numbers of the pixels, color information entropy as a feature quantity is acquired for each pixel of each image data (step S04 in FIG. 2). The color information entropy is acquired for a predetermined pixel region including each pixel, here, a predetermined neighborhood pixel region centered on a given pixel. The extensive state quantity (feature quantity) indicating the amount of color information and the degree of disorder in the neighborhood pixel region corresponds to the color information entropy, and can be calculated as follows. Therefore, the feature quantity of an image can be calculated by using the color information entropy.

More specifically, as shown in FIG. 9, for example, regarding a pixel E positioned at the pixel coordinates x=5, y=4, a region of “±three pixels” around the pixel E, i.e., a region represented by 3≦x≦7, 2≦y≦6 is set as the neighborhood pixel region. It is noted that the neighborhood pixel region is set as appropriate in accordance with the content of image data to be analyzed, and here, is set as “±three pixels” in advance. Therefore, the neighborhood pixel region may be set by another method. As another example of the neighborhood pixel region, instead of a rectangular region, a rhombus region may be set for the pixel E as shown in FIG. 10.

As a criterion for the number of pixels in the neighborhood pixel region to be set, if one worker is captured within an image range of 320×240 pixels, it is considered that, for example, about 5×5 pixels are appropriate as the number of pixels that enables recognition of an object of 5 square cm. Thus, the neighborhood pixel region is set as appropriate in accordance with the capability of recognition of a worker and an object that performs work.

Next, color information entropy EPY_{x,y} of a pixel at the pixel coordinates x, y is calculated by the following (Expression 1).

$$\begin{matrix}Mathematical . 1 & \\ {EPY}_{x , y} = {\sum }_{c} \{ - {p}_{x , y} ( c ) \times {log}_{2} {p}_{x , y} ( c ) \} & ( Expression 1 )\end{matrix}$$

In the above (Expression 1), p_{x,y}(c) indicates the proportion of an area in which a color pallet number c is included, in the neighborhood pixel region about the pixel position x, y. Therefore, for p_{x,y}(c), the proportion of the number N_{x,y}(c) of pixels corresponding to the color pallet number c, in the number N of neighborhood pixels which is the number of pixels in the neighborhood pixel region, can be calculated by the following (Expression 2).

p_{x,y}(c)=N_{x,y}(c)/N (Expression 2)

Specifically, FIG. 11 shows examples of image data with color information entropies calculated. In FIG. 11, a neighborhood pixel region composed of 5×5=25 pixels in image data is shown as an example. In FIG. 11 to FIG. 13, for facilitating the understanding, colors (white, black, gray, etc.) are shown, though actually processing is performed with color pallet numbers. Thus, the description thereof is omitted as appropriate.

A neighborhood pixel region 61 in FIG. 11(a) entirely indicates a single color, “white”. A neighborhood pixel region 62 in FIG. 11(b) entirely indicates a single color, “gray”. Thus, in FIGS. 11(a) and (b), the number of color information is one and there is no disorder, and therefore the color information entropy calculated by the following (Expression 3) becomes “0”.

EPY_{x,y}=−1×log(1)=0 (Expression 3)

On the other hand, a neighborhood pixel region 63 in FIG. 11(c) includes seven pixels in “black”, five pixels in “dark gray”, six pixels in “light gray”, and seven pixels in “white”. Therefore, the color information entropy is calculated by the following (Expression 4), and becomes “1.99”.

EPY_{x,y}=−(7/25)log₂(7/25)−(5/25)log₂(5/25)−(6/25)log₂(6/25)−(7/25)log₂(7/25)=1.99 (Expression 4)

Thus, in FIG. 11(c), there are a lot of different color pallet numbers (color information amount) and there is disorder, and therefore the color information entropy becomes “1.99”. In the color pallet data 15 shown above, there are no setting examples of the color pallet numbers for “dark gray” and “light gray”, but these colors are used for facilitating the understanding of FIG. 11.

The case where a grid-like pattern G slightly shifts from lower left to upper right in a neighborhood pixel region 64 with respect to a pixel F of image data as shown in FIG. 12(a) and FIG. 12(b), will be described. Thus, even if change occurs as shown in FIG. 12(a) and FIG. 12(b), the ratio between “gray” and “white” in the neighborhood pixel region 64 of the pixel F does not change. Therefore, the degree of disorder of image data in the neighborhood pixel region 64 does not change. Therefore, the color information entropy becomes “0.94” in FIG. 12(b) from “0.94” in FIG. 12(a), and thus does not change.

Thus, by using the property of the color information entropy, it becomes possible to eliminate influence of image blur or the like due to, for example, shake which is likely to occur in a factory. Also in capturing at locations other than a factory, such influence as in the case where image blur is likely to occur can be eliminated in the same manner. In addition, it is considered that influence of error can also be eliminated.

Next, FIG. 13 is a diagram showing an example in which a part of a gray pattern passes from below to above in the neighborhood pixel region 64 of the pixel H. In this example, the ratio between “gray” and “white” in the neighborhood pixel region 64 of the pixel H changes as the gray pattern passes. Thus, the color information entropy value changes as shown in FIG. 16(a) to FIG. 16(j). That is, by the degree of disorder of the image data changing, the color information entropy changes. It is found that, by using this property, it is possible to determine whether or not a moving object moves on the image data.

As shown in FIG. 14, information about color information entropy at each elapsed time, i.e., for each image data in time series, is acquired at each pixel position, and change in the color information entropy with elapse of time can be confirmed. Then, color information entropy for each pixel of all the image data is acquired, and stored as feature quantity time-series data in the feature quantity time-series DB 11, and thus the process is ended.

Regarding the image data from which color information entropies have been acquired, the magnitudes of values of the color information entropies at the respective pixel positions at a given point of time are plotted in grayscale, whereby, for example, as shown in FIG. 15(a), an object such as a worker having complex shape and colors can be recognized and a work scene image of the worker can be obtained. In addition, as shown in FIG. 15(b), with reference to a graph in which the horizontal axis indicates the position and the vertical axis indicates the value of color information entropy at each position on Z-Z′ line in FIG. 15(a), it is confirmed that information about the worker or the like can be recognized.

Next, on the basis of the feature quantity time-series data, the variation cycle calculation unit 8 performs image analysis about the work cycle period of the worker by using a time-series variation cycle of the feature quantity. Specifically, the image analysis is executed in three steps of: calculating an autocorrelation coefficient of feature quantity time-series data, calculating a variation cycle by using the autocorrelation coefficient value, and analyzing the work cycle period by using the variation cycle.

First, all feature quantity time-series data for each pixel are read (step S21 in FIG. 16). These data are expressed as a graph in which the horizontal axis indicates time (elapsed second) and the vertical axis indicates color information entropy, as shown in FIG. 17. As shown in FIG. 17, distinctive waveforms exist at J1, K1, J2, and K2. A waveform for a pixel existing at J1 in FIG. 17 is extracted as shown in FIG. 18. In addition, a waveform for a pixel existing at K1 in FIG. 17 is extracted as shown in FIG. 19.

As shown in FIG. 18, it is found that “J1” and “J2” are paired and distinctive waveforms exist there. In addition, as shown in FIG. 19, it is found that “K1” and “K2” are paired and distinctive waveforms exist there. Thus, it is found that similar waveforms are cyclically repeated. This is because, in the case where a worker performs repetitive work, color information entropies vary every time a part of the body, a work, a tool, or the like cyclically passes through a given point (pixel coordinates) on the image.

The reason that, as described above, regarding the color information entropies of the respective pixels, the cycle phases of the waveforms of the respective pixels do not coincide with each other, that is, the peak appearance times at J1 and K1 are different, will be described. For example, in a screen as shown in FIG. 20(a), the position of a pixel J and the position of a pixel K are different. As shown in FIG. 20(b), after a moving object 80 passes through the coordinates of the pixel J, the moving object 80 passes through the coordinates of the pixel K, and thus a time difference occurs. This is a cause to make the peak appearance times different as described above.

Next, an autocorrelation coefficient is calculated for each pixel (step S22 in FIG. 16). That is, if the cyclic time-series data are shifted by a certain time (hereinafter, referred to as “time shift”), the point of time at which the degree of coincidence between waveforms enhances (that is, the autocorrelation increases) as shown in FIG. 21(a) and FIG. 21(b) is reached. The time interval between the points of time at which the autocorrelation increases is regarded as a work cycle period, and the work cycle period can be detected by calculating the autocorrelation coefficient for each time shift.

Therefore, an autocorrelation coefficient R(t, t+Δs) between a time-series data value Xt at time t and a time-series data value Xt+Δs at the time at which time shift has been performed by Δs from time t, is calculated by the following (Expression 5). E[f(t)] is an expectation of f(t). In addition, μ is an average value of X, and σ is a standard deviation of X. In addition, “value” in this expression refers to “value” of color feature entropy.

R(t,t+Δs)={E[(Xₜ−μ)(X_{t+Δs}−μ)]/σ² (Expression 5)

Then, autocorrelation coefficients of all the pixels for each time shift are calculated by the above (Expression 5). As a result, as shown in FIG. 22, autocorrelation coefficients of the pixels for each time shift are calculated. The values calculated as shown in FIG. 22 are indicated as shown in FIG. 23 in which the vertical axis indicates the autocorrelation coefficient and the horizontal axis indicates the time shift.

Next, the variation cycle is calculated by using the autocorrelation coefficients (step S23 in FIG. 16). First, the average value of the autocorrelation coefficients of all the pixels for each time shift is calculated. The average values are calculated as shown in FIG. 24. The values calculated as shown in FIG. 24 are shown in FIG. 25 in which the vertical axis indicates the autocorrelation coefficient and the horizontal axis indicates the time shift. As is obvious from FIG. 25, regarding the variation cycle of color information entropy, it can be confirmed that a great correlation appears at intervals of “12 to 13 sec”. Although the variation cycle can be calculated from the average value of the autocorrelation coefficients, the following operation is performed in order to improve the accuracy of the value of the variation cycle.

Next, Fourier transform is performed for the autocorrelation coefficient, thereby clarifying the variation cycle of the autocorrelation coefficient. Fourier transform is performed for the autocorrelation coefficient shown in FIG. 25, and the resultant values are shown in FIG. 26 in which the vertical axis indicates a power spectral density (PSD) and the horizontal axis indicates the cycle. From FIG. 26, it is confirmed that there is a peak at “11.2 sec”. Thus, the calculation result is that the work is performed with a cycle (variation cycle) of “11.2 sec”.

Next, the work cycle period is analyzed by using the variation cycle calculated as described above and the feature quantity time-series data of each pixel (step S24 in FIG. 16). First, the time shift corresponding to the time when the local maximum of the autocorrelation coefficient for each pixel appears, this autocorrelation coefficient (local maximum), and the initial time at which the local maximum initially appears, are extracted as shown in FIG. 27. In the data extracted in FIG. 27, naturally, image data other than work by a worker can be included at each pixel, and therefore it is assumed that a local maximum not having the above variation cycle also exists.

Therefore, from the data in FIG. 27, in order to remove images other than work by a worker among the pixels, data having the variation cycle of “11.2 sec” calculated above, i.e., the local maximums of the autocorrelation coefficients having the variation cycle of “11.2 sec” are only extracted. The data thus extracted from FIG. 27 are shown in FIG. 28. In this example, the autocorrelation coefficients of a plurality of pixels exhibit local maximums with the variation cycle of “11.2 sec”. As for the initial times at which the local maximums of the respective autocorrelation coefficients appear, there are both a case where the initial times are the same and a case where the initial times are different.

That is, as shown in FIG. 29 corresponding to the positions of pixels 75, 76, and 77 shown in FIG. 28, although the time at which a moving object 80 initially passes through the position (x=20, y=157) of the pixel 75 is 6.6 sec, the time at which the moving object 80 initially passes through the position (x=147, y=79) of the pixel 76 and the position (x=148, y=80) of the pixel 77 is 10.0 sec, and thus these times are different. From this, it can be estimated that it takes 3.4 sec for the moving object 80 to move from the pixel 75 to the pixel 76 and the pixel 77.

In other words, this means that a work time taken to move the moving object 80 from the position of the pixel 75 to the positions of the pixel 76 and the pixel 77 is 3.4 sec. By using this theory, it is possible to analyze the time taken for any section (section in which a moving object moves from a given pixel to another given pixel) within one cycle period of work.

Next, with reference to FIG. 30 to FIG. 32, a specific example of the method for analyzing a work cycle period (which means one cycle period of work) will be described. FIG. 30 shows data obtained by excluding redundant data indicating the same initial time from the data in FIG. 28. Specifically, since the pixel 76 and the pixel 77 indicate the same initial time, only data of the pixel 76 is left and data of the pixel 77 is deleted. In this way, data indicating different initial times are rearranged as work points “No. 1”, “No. 2”, . . . , in order from the earliest one of the initial times.

Next, among these work points, the work points “No. 1” and “No. 2” are selected, and pixel feature quantity time-series data of pixels corresponding to the selected work points are extracted. Then, the times at which the local maximums of the autocorrelation coefficients appear are rearranged in time ascending order. FIG. 31 shows an example of the data extracted in this way. In FIG. 30 to FIG. 32, the work points “No. 1” and “No. 2” respectively indicate the same pixel positions.

The times (hereinafter, referred to as “work times”) corresponding to the local maximums of the autocorrelation coefficients for the respective work points appear in an alternate order, “No. 1”, “No. 2”, “No. 1”, “No. 2”, . . . , in principle. Therefore, for each work cycle, the work time difference between work points, i.e., the work cycle period can be calculated.

Specific description will be given with reference to FIG. 32. In FIG. 32, in the first work cycle, the work time at the work point “No. 1” is “6.6 sec”, and the work time at the work point “No. 2” is “10.0 sec”, and in the second work cycle, the work time at the work point “No. 1” is “17.8 sec”, and the work time at the work point “No. 2” is “21.1”.

In this case, the section between the work point “No. 1” and the work point “No. 2” is referred to as section 1, and the section between the work point “No. 2” and the work point “No. 1” is referred to as section 2. The work period in the section 1 is, in the first work cycle, “3.4 sec” which is the difference between work time “10.0 sec” at the work point “No. 2” and work time “6.6 sec” at the work point “No. 1”, and in the second work cycle, “3.3 sec” which is the difference between work time “21.1 sec” at the work point “No. 2” and work time “17.8 sec” at the work point “No. 1”.

The work period in the section 2 is, in the first work cycle, “7.8 sec” which is the difference between work time “10.0 sec” at the work point “No. 2” and work time “17.8 sec” at the work point “No. 1” in the second work cycle, and in the second work cycle, “7.8 sec” which is the difference between work time “21.1 sec” at the work point “No. 2” and work time “28.9 sec” at the work point “No. 1” in the third work cycle.

Then, the sum of the section 1 and the section 2, i.e., the sum of “3.4 sec” and “7.8 sec”=“11.2 sec”, and the sum of “3.3 sec” and “7.8 sec”=“11.1 sec” are calculated. Thus, for each work cycle, the work time interval between the work points in each section can be measured. In this way, measurement is performed for all the pixels, the work time interval data are stored as image analysis data in the image analysis DB 12, and the process is ended.

The image analysis data analyzed by the image analysis device 5 are displayed on the display device 13 for the analyst 14 via the communication network 4. For the analyst 14, for example, the image analysis data are displayed as variations in the work time intervals as shown in FIG. 33. Thus, the image analysis data can be provided to the analyst 14. In this example, variations in the work periods in the section 2 are greater than variations in the work periods in the section 1, and the analyst 14 can perform such image analysis that a problem may arise on work in the section 2.

In the above embodiment 1, an example in which, in detection of the variation cycle for extracting the work points, autocorrelation coefficients are calculated by using the color information entropies of all the pixels and then averaged to calculate the variation cycle, has been described. However, without limitation thereto, another method for calculating the variation cycle will be described below.

As shown in FIG. 34, time-series data of color information entropies for one given pixel are extracted. This example shows the case where an operation including, in one cycle, four sets of basic operations for 10 sec each time, e.g., a screwing operation on four parts per one work is repeatedly performed for a plurality of works. Then, from the data as shown in FIG. 34, autocorrelation coefficients are calculated in the same manner as in the above embodiment 1, and they are shown in FIG. 35 in which the vertical axis indicates the autocorrelation coefficient and the horizontal axis indicates time shift.

As is found from FIG. 35, a great correlation M appears with time shift of about 10 sec, and a correlation N cyclically appears with every time shift of about 50 sec. It is considered that the correlation M in a short period is due to repetition of short basic operations performed in one work cycle. On the other hand, it is considered that, as for the four sets of operations in one cycle, the correlation N is obtained in cycle of about 50 sec.

Next, as in the above embodiment 1, Fourier transform is performed in order to clarify the variation cycle of the autocorrelation coefficient in FIG. 35. Fourier transform is performed for the autocorrelation coefficient shown in FIG. 35, and the resultant values are shown in FIG. 36 in which the vertical axis indicates a power spectral density (PSD) and the horizontal axis indicates the cycle. From FIG. 36, it is confirmed that there is a peak at “50 sec”. Thus, the calculation result is that the work is performed with a cycle (variation cycle) of “50 sec”. Thus, hereafter, by using the variation cycle, work points are extracted to perform work analysis as in the above embodiment 1.

Next, an advantage in the case where the variation cycle is calculated by the autocorrelation coefficient will be described. For example, it is assumed that work interruption in which work by a worker is interrupted in the middle is included in image data. Various causes such as an intermission, abrupt trouble, assist for others, and worker's leaving from the work are conceivable. During such work interruption, it is conceivable to interrupt acquisition of image data, for example. However, as described above, the cause for interruption is unknown. Even if the cause is known, complicated operations such as operation of interrupting acquisition of image data and operation of restarting acquisition of image data are needed, and depending on the timing thereof, there is a possibility that image analysis itself may be hampered.

Therefore, in the present embodiment, even if work interruption occurs, image data is continuously acquired, and even for image data that includes the work interruption, since the variation cycle is calculated by the autocorrelation coefficient, image analysis can be performed. This will be described below.

First, in the case where work interruption occurs, as shown in FIG. 37, the color information entropy of image data is “0” during the work interruption. In FIG. 37, except for the work interruption, the same work as in FIG. 34 is performed. From the data as shown in FIG. 37, autocorrelation coefficients are calculated as in the above embodiment 1, and they are shown in FIG. 38 in which the vertical axis indicates the autocorrelation coefficient and the horizontal axis indicates time shift. As is found from comparison between FIG. 38 and FIG. 35, since work interruption is included in FIG. 38, a stable waveform cannot be obtained.

However, Fourier transform is performed for this autocorrelation coefficient, and the resultant values are shown in FIG. 39 in which the vertical axis indicates a power spectral density (PSD) and the horizontal axis indicates the cycle. From FIG. 39, it is confirmed that there is a peak at “50 sec”. Thus, the calculation result is that the work is performed with a cycle (variation cycle) of “50 sec”. Thus, hereafter, work analysis can be performed as in the above embodiment 1.

However, without calculating the autocorrelation coefficient as described above, if Fourier analysis is merely performed for the color information entropy of image data, the result is as shown in FIG. 40 in which the vertical axis indicates a power spectral density (PSD) and the horizontal axis indicates the cycle. As is found from FIG. 40, many low-frequency components are detected and a peak cannot be confirmed at 50 sec which should be originally obtained.

In the image analysis device of embodiment 1 configured as described above, since image analysis can be performed using the feature quantity of image data obtained by capturing a worker in a facility, an analyst who performs analysis does not need to visually observe a worker who is an observation target, and a load of image analysis can be reduced. In addition, since the variation cycle of the feature quantity can be used for analysis, it is not necessary to recognize a moving object itself, and also, not necessary to prepare correspondence tables such as an operation dictionary, image analysis can be performed accurately. In addition, since the variation cycle is calculated from the autocorrelation coefficient, it is possible to calculate the variation cycle with high accuracy even if work interruption or the like occurs.

In addition, since the feature quantity time-series data are calculated by using color information entropies in time series about color information in a predetermined pixel region including each pixel, it is not necessary to discriminate a moving object and other objects in image data, and image analysis can be performed accurately.

In addition, since the variation cycle is calculated from the autocorrelation coefficient of the feature quantity time-series data, image analysis with high accuracy can be performed.

In addition, since color information is acquired on the basis of color pallet data classified into a plurality of predetermined divisions, image analysis can be performed in a simple manner.

In the above embodiment 1, an example in which the image analysis device includes the image analysis means, the image DB, the feature quantity time-series DB, and the image analysis DB, has been shown. However, without limitation thereto, even if these are separately provided, the same operation as in the above embodiment 1 can be performed, whereby the same effect can be provided. Specifically, as long as the image analysis device only includes the image analysis means, the same operation as in the above embodiment 1 can be performed by obtaining the other data from outside, whereby the same effect can be provided. The same also applies to the other embodiments below, and such description is omitted as appropriate.

In the above embodiment 1, an example in which two capturing locations are set has been shown, but the number of the capturing locations is not limited to two. Even in the case of one capturing location or three or more capturing locations, the same operation as in the above embodiment 1 can be performed, whereby the same effect can be provided.

### Embodiment 2

In the above embodiment 1, an example in which color pallet data are set in advance has been shown. However, without limitation thereto, in the present embodiment, the case where color pallet data are generated in accordance with the appearance frequency of color information in image data will be described. Thus, in the present embodiment, among operations of the feature quantity calculation unit 7, particularly, operation of setting color pallet data will be described. The other configuration and operation are the same as in the above embodiment 1, and therefore the description thereof is omitted as appropriate.

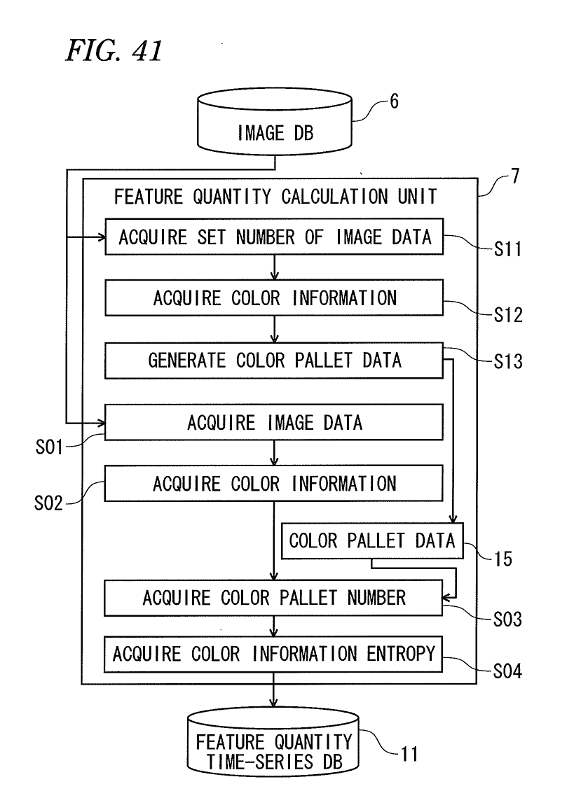

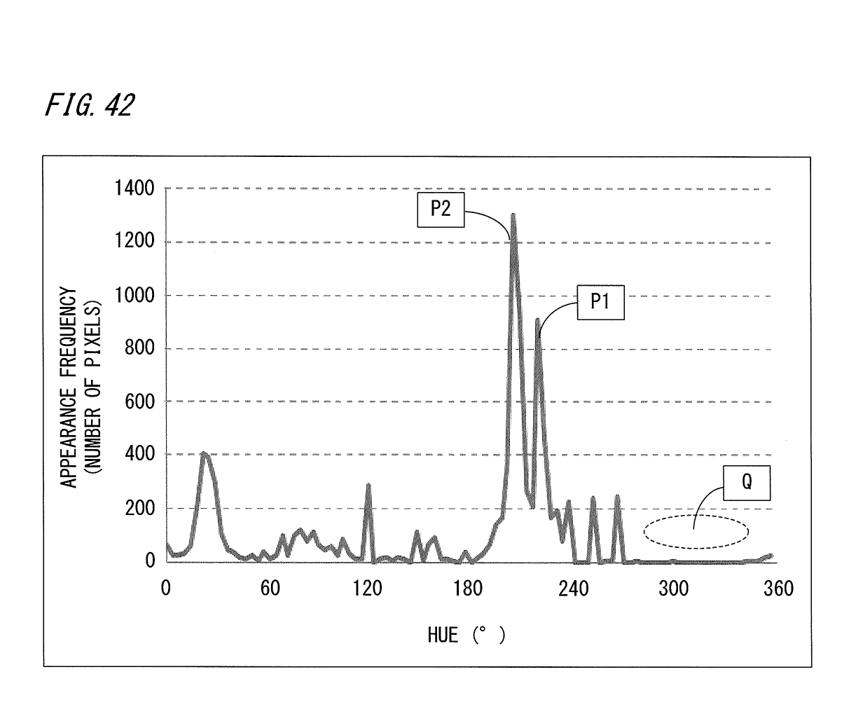

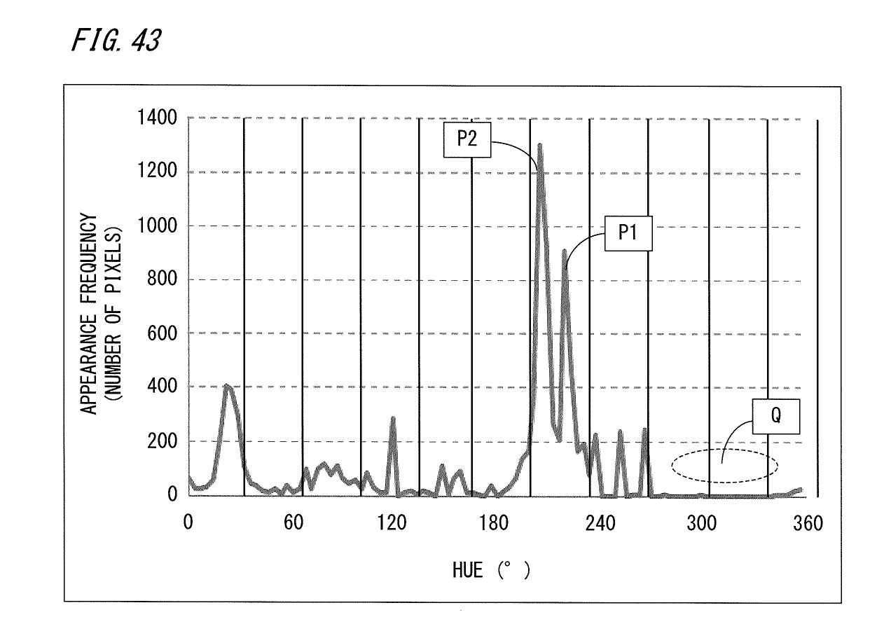

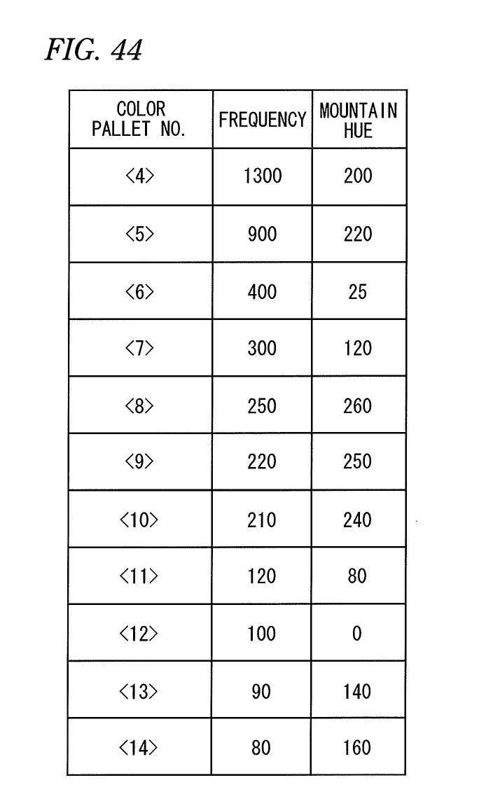

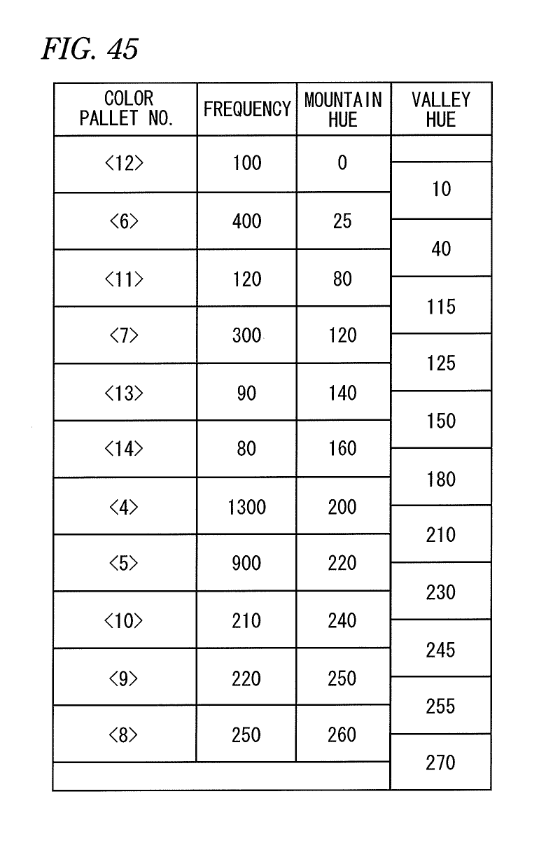

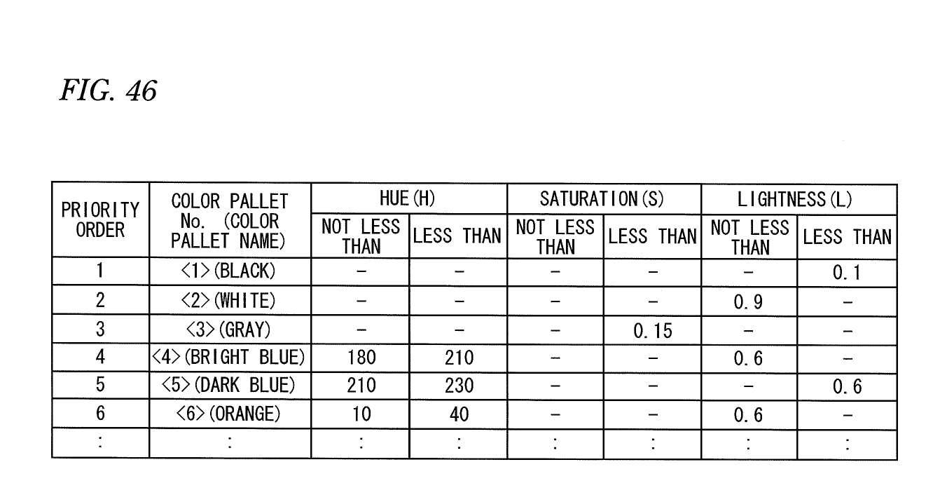

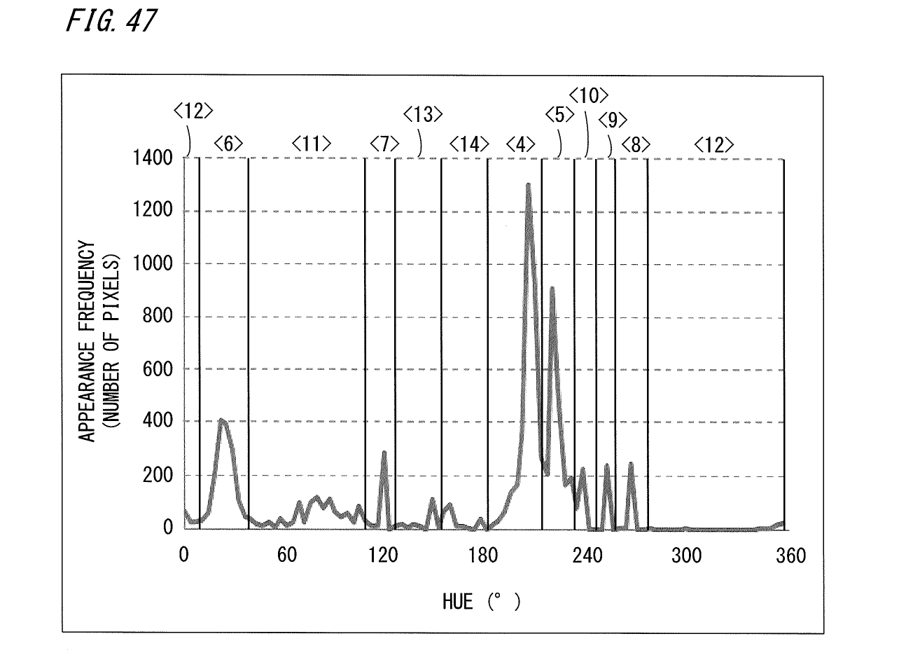

FIG. 41 is a diagram for explaining operation of a feature quantity calculation unit of an image analysis device according to embodiment 2 of the present invention. FIG. 42 is a diagram showing the appearance frequency for each hue in image data acquired by the feature quantity calculation unit shown in FIG. 41. FIG. 43 is a diagram showing the appearance frequency for each hue shown in FIG. 41, in an equally divided manner in terms of hue. FIG. 44 is a diagram showing, in descending order, the appearance frequency for each hue in the image data shown in FIG. 41, and showing mountain hues extracted therefrom. FIG. 45 is a diagram obtained by rearranging, in hue order, the appearance frequencies arranged in descending order shown in FIG. 44, and extracting valley hues. FIG. 46 is a diagram showing the state of color pallet numbers set from the valley hues shown in FIG. 45. FIG. 47 is a graph showing the appearance frequency for each hue shown in FIG. 41, with the hue divided into the color pallet numbers shown in FIG. 46.

The feature quantity calculation unit 7 of the image analysis device of embodiment 2 configured as described above acquires and reads a predetermined number of image data (step S11 in FIG. 41). In this case, the number of image data to be acquired is set as appropriate in accordance with the type of image data to be analyzed, the accuracy of analysis, or the like. Next, the same process as in the above embodiment 1 is performed, and color information about all pixels of each acquired image data is acquired (step S12 in FIG. 41). The acquired color information about the pixels of each image data may be used in step S02 described later.

Next, color pallet data are generated (step S13 in FIG. 41). First, the appearance frequency of each hue of the color information about all the pixels of each read image data is calculated. Then, by expressing the appearance frequency of each hue in this case as a graph in which the horizontal axis indicates the hue and the vertical axis indicates the appearance frequency, a distribution as shown in FIG. 42 is obtained. In the image data, for example, in the case of inside of a factory, generally, the scene of a workplace is often somber with few primary colors.

Therefore, as shown in FIG. 42, there is a color zone Q with almost no appearance frequency. On the other hand, as shown in a color zone P1 and a color zone P2 in FIG. 42, there are parts indicating high appearance frequencies at similar colors. Therefore, in analysis, it is not necessary to finely classify the color pallet numbers for the part indicated by the color zone Q, and it is considered that, if the color pallet numbers are set in a divided manner for the parts indicating high appearance frequencies such as the color zone P1 and the color zone P2, the analysis can be performed accurately.

However, if FIG. 42 is merely shown so as to be equally divided in terms of hue, classification is made as shown in FIG. 43 so that two color pallet numbers are allocated for the color zone Q indicating little appearance frequency, and an identical color pallet number is allocated for both the color zone P1 and the color zone P2 indicating high appearance frequencies. Thus, in this state, it is impossible to accurately acquire color information in a factory.

Therefore, in the present embodiment 2, excluding color pallet numbers defined by lightness or saturation irrespective of hue, such as the color pallet number <1> (black) at the first priority order, the color pallet number <2> (white) at the second priority order, and the color pallet number <3> (gray) at the third priority order, eleven color pallet numbers are set in order from the hue indicating the highest appearance frequency.

For the hues (corresponding to mountain-like parts in FIG. 42, hereinafter, referred to as “mountain hues”) indicating high appearance frequencies, <4> to <14> are allocated in order from the part indicating the highest appearance frequency. In FIG. 41, since the appearance frequency is the highest near a hue of 200°, the color pallet number <4> at the fourth priority order is allocated so as to include the mountain hue of 200°. The color pallet number <5> at the fifth priority order is allocated so as to include a hue of 220° indicating the next highest appearance frequency. Thus, as shown in FIG. 44, allocation is sequentially performed for eleven mountain hues. Then, as shown in FIG. 45, the eleven mountain hues are rearranged in order from the smallest hue. Then, the hue (hereinafter, referred to as “valley hue”) indicating the smallest appearance frequency between the adjacent mountain hues is detected.

Then, for each color pallet number, as shown in FIG. 46, the color zone width between the adjacent valley hues is set as a color pallet border condition. That is, for example, for the color pallet number <4> at the fourth priority order, a condition that the hue is not less than 180° but less than 210° is allocated. By such setting, in the color pallet data, the color zone width of each color pallet number is made variable in accordance with the appearance frequencies of hues.

Then, in the color pallet data, the color pallet numbers are respectively registered. As a result, as shown in FIG. 46, one color pallet number is set for the part indicated by the color zone Q, and different color pallet numbers are set for the color zone P1 and the color zone P2. Therefore, it is considered that analysis can be performed accurately. Hereafter, the same process as in the above embodiment 1 is performed using the color pallet data set in accordance with the output frequencies.

In embodiment 2 configured as described above, as well as providing the same effect as in the above embodiment 1, it is possible to set color pallet data in accordance with the appearance frequencies of color information in image data, whereby the image analysis can be accurately performed in accordance with the content of the image data.

### Embodiment 3

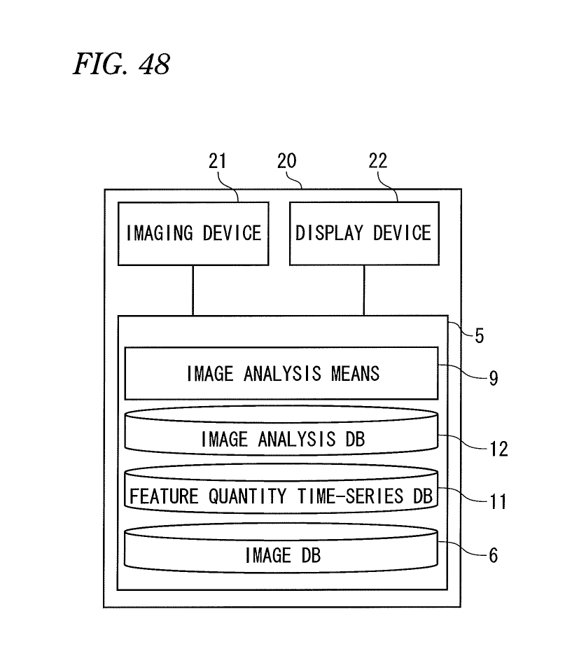

In the above embodiments, an example in which the imaging device, the image analysis device, and the display device are provided in a distributed manner as an image analysis system has been shown. However, without limitation thereto, as shown in FIG. 48, a tablet-type mobile terminal device 20 includes: an imaging device 21 for capturing an image; a display device 22 for displaying information; and an image analysis device 5. The image analysis device 5 includes the image analysis means 9, the image DB 6, the feature quantity time-series DB 11, and the image analysis DB 12, as in the above embodiments. Thus, the same operation as in the above embodiments can be performed.

In embodiment 3 configured as described above, as well as providing the same effect as in the above embodiments, since a mobile terminal device is provided with the functions, the portability can be enhanced. In such a case of analyzing the content of work, each worker or analyst can carry the mobile terminal device and perform image analysis at the site where work or analysis is performed. Therefore, image analysis can be performed even if a facility of an imaging device and a display device is not present at the site. In addition, since it is not necessary to provide communications between the image analysis device, and the imaging device and the display device, high versatility is achieved.

### Embodiment 4

In the above embodiments, an example in which the image analysis device includes the image analysis means, the image DB, the feature quantity time-series DB, and the image analysis DB. However, without limitation thereto, the image DB for storing image data may be provided on the imaging device side.

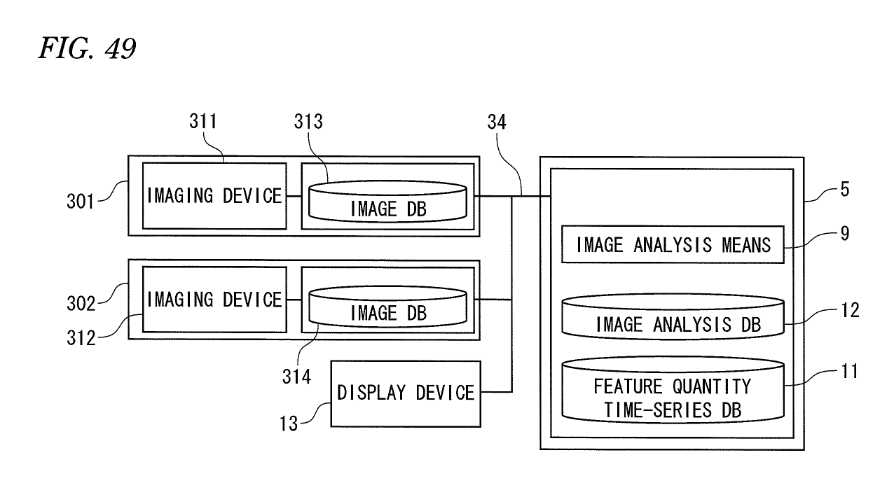

Specifically, as shown in FIG. 49, the image analysis device 5 includes the image analysis means 9, the feature quantity time-series DB 11, and the image analysis DB 12, as in the above embodiments. The display device 13 is connected via a wired or wireless communication network 34. Imaging units 301 and 302 composed of, for example, general household video cameras are connected via the communication network 34. The imaging units 301 and 302 respectively include: imaging devices 311 and 312 for capturing images; and image DB 313 and 314 (which may be a hard disk or an SD card of a video camera, etc.) in which image data captured by the imaging devices 311 and 312 are stored. Thus, the same operation as in the above embodiments can be performed.

In the image analysis system of embodiment 4 configured as described above, as well as providing the same effect as in the above embodiments, the imaging units can be inexpensively extended in response to increase in targets to be captured. In the present embodiment 4, an example in which two imaging units are connected has been shown. However, without limitation thereto, the same operation can be performed even in the case of providing one imaging unit or three or more imaging units, whereby the same effect can be provided.

It is noted that, within the scope of the present invention, the above embodiments may be freely combined with each other, or each of the above embodiments may be modified or abbreviated as appropriate.

1. An image analysis method for analyzing image data acquired in time series, the image analysis method comprising:
a step of acquiring color information about each pixel of each image data;
a step of calculating feature quantity time-series data indicating time-series change in a feature quantity of each pixel, from the color information; and
a step of calculating a variation cycle of the image data from the feature quantity time-series data;
wherein
the feature quantity time-series data are time-series color information entropies of the color information in a predetermined pixel region including each pixel.

2. (canceled)

3. The image analysis method according to claim 1, wherein
the variation cycle is calculated from an autocorrelation coefficient of the feature quantity time-series data.

4. The image analysis method according to claim 1, wherein
the color information is acquired on the basis of color pallet data classified into a plurality of predetermined divisions.

5. The image analysis method according to claim 4, wherein
the divisions of the color pallet data are set in accordance with an appearance frequency of a color in the image data.

6. The image analysis method according to claim 1, wherein the image data include data indicating repetition of cyclic operation by a worker in a factory,
the image analysis method comprising a step of analyzing a cycle of the operation repeated by the worker, from the variation cycle.

7. An image analysis device for analyzing image data acquired in time series, the image analysis device comprising:
a feature quantity calculation unit for calculating feature quantity time-series data indicating time-series change in a feature quantity, from color information about each pixel of each image data; and
a variation cycle calculation unit for calculating a variation cycle of the image data from the feature quantity time-series data;
wherein
the feature quantity time-series data are time-series color information entropies of the color information in a predetermined pixel region including each pixel.

8. (canceled)

9. An image analysis system comprising:
an image analysis device for analyzing image data acquired in time series, the image analysis device comprising:
a feature quantity calculation unit for calculating feature quantity time-series data indicating time-series change in a feature quantity, from color information about each pixel of each image data; and
a variation cycle calculation unit for calculating a variation cycle of the image data from the feature quantity time-series data;
wherein
the feature quantity time-series data are time-series color information entropies of the color information in a predetermined pixel region including each pixel,
an imaging device for acquiring the image data;
a display device for displaying a result of analysis by the image analysis device;
an image database in which the image data are stored;
a feature quantity time-series database in which the feature quantity time-series data are stored; and
an image analysis database in which the result of analysis is stored.

10. The image analysis system according to claim 9, wherein the image analysis device, the imaging device, the display device, the image database, the feature quantity time-series database, and the image analysis database are configured so as to be integrated and portable.

11. The image analysis method according to claim 3, wherein
the color information is acquired on the basis of color pallet data classified into a plurality of predetermined divisions.

12. The image analysis method according to claim 11, wherein
the divisions of the color pallet data are set in accordance with an appearance frequency of a color in the image data.

13. The image analysis method according to claim 3, wherein the image data include data indicating repetition of cyclic operation by a worker in a factory,
the image analysis method comprising a step of analyzing a cycle of the operation repeated by the worker, from the variation cycle.

14. The image analysis method according to claim 4, wherein the image data include data indicating repetition of cyclic operation by a worker in a factory,
the image analysis method comprising a step of analyzing a cycle of the operation repeated by the worker, from the variation cycle.

15. The image analysis method according to claim 7, wherein
the variation cycle is calculated from an autocorrelation coefficient of the feature quantity time-series data.

16. The image analysis method according to any one of claim 7, wherein
the color information is acquired on the basis of color pallet data classified into a plurality of predetermined divisions.

17. The image analysis method according to claim 16, wherein
the divisions of the color pallet data are set in accordance with an appearance frequency of a color in the image data.

18. The image analysis method according to claim 7, wherein the image data include data indicating repetition of cyclic operation by a worker in a factory,
the image analysis method comprising a step of analyzing a cycle of the operation repeated by the worker, from the variation cycle.

19. The image analysis method according to claim 15, wherein
the color information is acquired on the basis of color pallet data classified into a plurality of predetermined divisions.

20. The image analysis method according to claim 19, wherein
the divisions of the color pallet data are set in accordance with an appearance frequency of a color in the image data.

21. The image analysis method according to claim 15, wherein the image data include data indicating repetition of cyclic operation by a worker in a factory,
the image analysis method comprising a step of analyzing a cycle of the operation repeated by the worker, from the variation cycle.

22. The image analysis method according to claim 16, wherein the image data include data indicating repetition of cyclic operation by a worker in a factory,
the image analysis method comprising a step of analyzing a cycle of the operation repeated by the worker, from the variation cycle.
